(19) United States
(12) Patent Application Publication
(10) Pub. No.: US 2025/0303732 A1
(43) Pub. Date: Oct. 2, 2025

(54) VALVE MECHANISM, LIQUID FLUID DEVICE, AND LIQUID EJECTION DEVICE

(71) Applicant: SEIKO EPSON CORPORATION, Tokyo (JP)

(72) Inventors: Tomohiro KAWASAKI, SHIOJIRI-SHI (JP); Yuki HIRABAYASHI, SHIOJIRI-SHI (JP); Masaru KOBASHI, MATSUMOTO-SHI (JP)

(21) Appl. No.: 19/091,124

(22) Filed: Mar. 26, 2025

(30) Foreign Application Priority Data
Mar. 27, 2024 (JP) 2024-051312
Jun. 5, 2024 (JP) 2024-091544
Jun. 5, 2024 (JP) 2024-091545
Jun. 5, 2024 (JP) 2024-091546

(51) Int. Cl. B41J 2/175

(52) U.S. Cl. CPC B41J 2/17596; B41J 2/17523

(57) ABSTRACT

It includes a first upstream chamber, a first downstream chamber that includes a first flexible membrane and that is in communication with the first upstream chamber via a first communication port downstream from the first upstream chamber, a second flexible membrane that partitions the first upstream chamber and the first downstream chamber from each other, a first open and close section configured to open and close the first communication port, a first biasing section that biases the first flexible membrane, wherein the first open and close section includes a first shaft section that is provided across the first upstream chamber and the first downstream chamber and that is configured to move following displacement of the first flexible membrane and the second flexible membrane and a first valve section that opens and closes the first communication port.

The present application is based on, and claims priority from JP Application Serial Number 2024-091545, filed Jun. 5, 2024, JP Application Serial Number 2024-051312, filed Mar. 27, 2024, JP Application Serial Number 2024-091546, filed Jun. 5, 2024, and JP Application Serial Number 2024-091544, filed Jun. 5, 2024, the disclosures of which are hereby incorporated by reference herein in their entirety.

### BACKGROUND

### 1. Technical Field

The present disclosure relates to a valve mechanism, a liquid fluid device, and a liquid ejection device.

### 2. Related Art

For example, as in JP-A-10-149223, there is a pressure reducing valve, which is an example of a valve mechanism. The pressure reducing valve includes a valve main body, a valve body, which is an example of a valve section, and a seal member. The valve main body includes a primary-side pressure chamber, which is an example of an upstream chamber, a secondary-side pressure chamber, which is an example of a downstream chamber, a first slide hole, and a valve hole, which is an example of a communication port. The first slide hole and the valve hole have the same central axis. The valve body is inserted into the first slide hole and the valve hole, and the valve body opens and closes the valve hole. The seal member closes gaps between the first slide hole and the valve body.

The seal member of JP-A-10-149223 is a so-called O-ring with a circular cross-section. The O-ring closes gaps between the first slide hole and the valve body by being squashed. The more the O-ring is squashed, the more the degree of sealing improves and leakage is reduced. However, when the O-ring is squashed, the frictional resistance increases. Therefore, the pressures at which the open and close valve opens may vary.

### SUMMARY

A valve mechanism that overcomes the above issue includes an upstream chamber into which fluid flows via an inflow port; a downstream chamber that has a first flexible membrane 26 and that is in communication with the upstream chamber via a communication port downstream of the upstream chamber; a second flexible membrane 27 that partitions the upstream chamber and the downstream chamber from each other; an open and close section configured to open and close the communication port; and a biasing section that biases the first flexible membrane 26 in a direction in which volume of the downstream chamber decreases, wherein the open and close section includes a shaft section that is provided across the upstream chamber and the downstream chamber and that is configured to move following displacement of the first flexible membrane 26 and the second flexible membrane 27 and a valve section that is connected to the shaft section and that opens and closes the communication port.

A valve mechanism that overcomes the above issue includes an upstream chamber that has a first flexible membrane 26 and into which a fluid flows via an inflow port; a downstream chamber that is in communication with the upstream chamber via a communication port downstream of the upstream chamber; a second flexible membrane 27 that partitions the upstream chamber and the downstream chamber from each other; an open and close section configured to open and close the communication port; and a biasing section that biases the first flexible membrane 26 in a direction in which volume of the upstream chamber increases; wherein the open and close section includes a shaft section that is provided across the upstream chamber and the downstream chamber and that is configured to move following displacement of the first flexible membrane 26 and the second flexible membrane 27 and a valve section that is connected to the shaft section and that opens and closes the communication port.

A liquid fluid device that overcomes the above issue includes the valve mechanism configured as described above and a liquid storage section configured to store liquid; a liquid flow path coupled to the liquid storage section; and a pressure varying mechanism configured to vary the pressure of liquid flowing through the liquid flow path, wherein the valve mechanism is provided in the liquid flow path.

A liquid ejection device that overcomes the above issue includes the liquid fluid device configured as described above and a liquid ejection section provided in the liquid flow path, wherein the valve mechanism is provided upstream of the liquid ejection section in the liquid flow path.

### BRIEF DESCRIPTION OF THE DRAWINGS

FIG. 1 is a schematic view of a first embodiment of a liquid ejection device.

FIG. 2 is a schematic cross-sectional view of a pressure adjustment valve included in the liquid ejection device.

FIG. 3 is a schematic cross-sectional view of a pressure release valve included in the liquid ejection device.

FIG. 4 is a schematic view of a second embodiment of a liquid ejection device.

FIG. 5 is a schematic cross-sectional view of a negative pressure adjustment valve included in the liquid ejection device.

FIG. 6 is a schematic cross-sectional view of a negative pressure release valve included in the liquid ejection device.

FIG. 7 is a schematic view of a first modification of the liquid ejection device.

FIG. 8 is a schematic view of a second modification of the liquid ejection device.

FIG. 9 is a schematic view of a third modification of the liquid ejection device.

FIG. 10 is a schematic view of a fourth modification of the liquid ejection device.

FIG. 11 is a schematic view of a fifth modification of the liquid ejection device.

FIG. 12 is a schematic view of a sixth modification of the liquid ejection device.

FIG. 13 is a schematic view of a seventh modification of the liquid ejection device.

FIG. 14 is a schematic view of an eighth modification of the liquid ejection device.

FIG. 15 is a schematic view of a ninth modification of the liquid ejection device.

FIG. 16 is a schematic view of a tenth modification of the liquid ejection device.

FIG. 17 is a schematic view of a twelfth modification of the liquid ejection device.

FIG. 18 is a schematic view of a thirteenth modification of the liquid ejection device.

FIG. 19 is a schematic view of the thirteenth modification of the liquid ejection device.

FIG. 20 is a schematic view of the fourteenth modification of the liquid ejection device.

FIG. 21 is a schematic view of the fifteenth modification of the liquid ejection device.

### DESCRIPTION OF EMBODIMENTS

### First Embodiment

Hereinafter, a first embodiment of a valve mechanism, a liquid fluid device, and a liquid ejection device will be described with reference to the drawings. A liquid ejection device is, for example, an inkjet printer that performs printing by ejecting ink, which is an example of a liquid, onto a medium such as paper, fabric, vinyl, plastic components, or metal components.

In the drawings, assuming that a liquid ejection device 11 is placed on a horizontal plane, the direction of gravity is indicated by a Z axis, and directions along the horizontal plane are indicated by an X axis and a Y axis. The X-axis, the Y-axis, and the Z-axis are orthogonal to each other. In the following description, a direction parallel to the Z-axis is also referred to as a vertical direction Z.

### Liquid Ejection Device

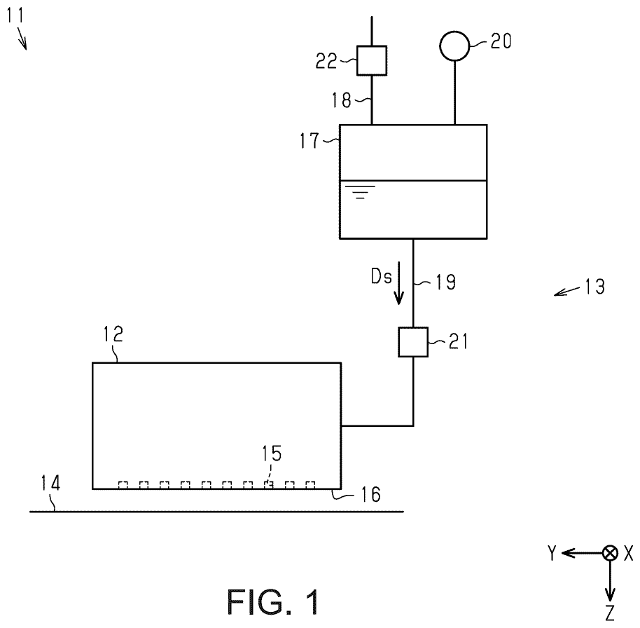

As shown in FIG. 1, the liquid ejection device 11 includes a liquid ejection section 12 and a liquid fluid device 13.

The liquid ejection section 12 is capable of ejecting liquid. The liquid ejection section 12 is configured to eject liquid onto a medium 14. The liquid ejection section 12 has a nozzle surface 16 in which one or more nozzles 15 are opened. The liquid ejection section 12 ejects liquid from the nozzles 15. The inside of the liquid ejection section 12 is normally maintained at a negative pressure. This is for forming a meniscus in the nozzles 15. By this, the liquid ejection section 12 can appropriately eject liquid.

### Liquid Fluid Device

The liquid fluid device 13 supplies liquid to the liquid ejection section 12 by causing the liquid to flow. The liquid fluid device 13 may include a liquid storage section 17, a gas flow path 18, a liquid flow path 19, a pressurizing pump 20, which is an example of a pressure varying mechanism, a pressure adjustment valve 21, which is an example of a valve mechanism and a first valve mechanism, and a pressure release valve 22.

The liquid storage section 17 stores liquid. The liquid storage section 17 is, for example, a tank that can be refilled with liquid.

The gas flow path 18 is connected to the liquid storage section 17. One end of the gas flow path 18 of the present embodiment is connected to the liquid storage section 17, and the other end is open to atmosphere.

The liquid flow path 19 is connected to the liquid storage section 17. The upstream end of the liquid flow path 19 with respect to a supply direction Ds is connected to the liquid storage section 17. The downstream end of the liquid flow path 19 with respect to the supply direction Ds is connected to the liquid ejection section 12. That is, the liquid ejection section 12 is provided in the liquid flow path 19. The liquid flow path 19 brings the liquid storage section 17 and the liquid ejection section 12 into communication with each other. Communication refers to connection in a state in which a fluid such as a liquid or a gas can flow. The liquid flow path 19 connects the liquid storage section 17 and the liquid ejection section 12 in a state in which fluid can flow. The liquid flow path 19 sends the fluid flowing out from the liquid storage section 17 to the liquid ejection section 12.

The pressurizing pump 20 can pressurize the inside of the liquid storage section 17. For example, the pressurizing pump 20 may pressurize the inside of the liquid storage section 17 by sending air into the liquid storage section 17. When the pressurizing pump 20 pressurizes the inside of the liquid storage section 17, the pressure of the liquid flowing out from the liquid storage section 17 increases. That is, the pressure pump 20 changes the pressure of the liquid flowing through the liquid flow path 19.

The pressure adjustment valve 21 is provided in the liquid flow path 19. The pressure adjustment valve 21 is provided upstream of the liquid ejection section 12 in the liquid flow path 19. The pressure adjustment valve 21 adjusts the pressure of the liquid supplied to the liquid ejection section 12 in the liquid flow path 19 to a positive set pressure. The set pressure is a pressure that is set in consideration of the flow path resistance or the like, and is a pressure sufficient to supply the liquid to nozzle 15 and yet not destroy the meniscus of nozzle 15.

The pressure release valve 22 is provided in the gas flow path 18. The pressure release valve 22 is coupled to the liquid storage section 17. The pressure release valve 22 can adjust the pressure of the liquid storage section 17. The pressure release valve 22 adjusts the positive pressure in the liquid storage section 17 by releasing the pressure in the liquid storage section 17.

### Pressure Adjustment Valve

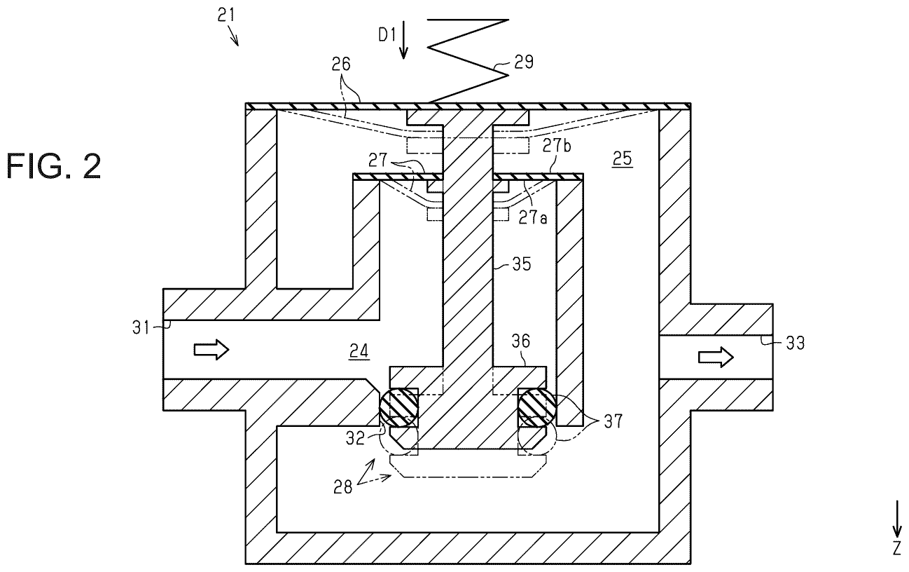

As shown in FIG. 2, the pressure adjustment valve 21 includes a first upstream chamber 24, which is an example of an upstream chamber, and a first downstream chamber 25, which is an example of a downstream chamber. The first downstream chamber 25 has a first flexible membrane 26. The pressure adjustment valve 21 includes a second flexible membrane 27, a first open and close section 28, which is an example of an open and close section, and a first biasing section 29, which is an example of a biasing section. The first open and close section 28 is movable between a closed position indicated by solid line in FIG. 2 and an open position indicated by two-dot chain line in FIG. 2. In the present embodiment, a state where the first open and close section 28 is positioned at the closed position is also referred to as the closed state, and a state where the first open and close section 28 is positioned at the open position is also referred to as the open state. In FIG. 2, the direction in which the fluid flows is indicated by white arrows.

The first upstream chamber 24 has a first inflow port 31, which is an example of an inflow port. The first inflow port 31 of the present embodiment communicates with the liquid storage section 17 via the liquid flow path 19. The fluid flows into the first upstream chamber 24 via the first inflow port 31. The fluid handled by the pressure adjustment valve 21 of the present embodiment is a liquid.

The first downstream chamber 25 is provided downstream of the first upstream chamber 24. Downstream of the first upstream chamber 24, the first downstream chamber 25 communicates with the first upstream chamber 24 via a first communication port 32, which is an example of a communication port. The first downstream chamber 25 has a first outflow port 33 through which the fluid flows out. The first outflow port 33 of the present embodiment communicates with the liquid ejection section 12 via the liquid flow path 19.

The first flexible membrane 26 forms a part of a wall of the first downstream chamber 25. The first flexible membrane 26 is formed of a flexible member having flexibility, such as a diaphragm. The first flexible membrane 26 is displaced according to a difference in pressures applied to the outer surface and the inner surface. The total of the atmospheric pressure and the biasing force of first biasing section 29 is applied to the outer surface of the first flexible membrane 26. The pressure of the fluid in the first downstream chamber 25 is applied to the inner surface of the first flexible membrane 26. In the closed state indicated by solid line in FIG. 2, the first flexible membrane 26 bends slightly. In the closed state, the first flexible membrane 26 is preferably in a flat state without bending. In the closed state, the first flexible membrane 26 may be in a slightly bent state. The bending amount of the first flexible membrane 26 when the first open and close section 28 is in the closed state indicated by solid line in FIG. 2 may be smaller than the bending amount of the first flexible membrane 26 when the first open and close section 28 is in the open state indicated by two-dot chain line in FIG. 2.

The second flexible membrane 27 partitions the first upstream chamber 24 and the first downstream chamber 25 from each other. The second flexible membrane 27 may be located above the first communication port 32. The second flexible membrane 27 is positioned between the first communication port 32 and the first flexible membrane 26. The first biasing section 29, the first flexible membrane 26, the second flexible membrane 27, and the first communication port 32 may be arranged in this order in the first direction D1. The first direction D1 may be the same as the vertical direction Z.

The second flexible membrane 27 is displaced according to the difference between the pressures applied to a first surface 27a and a second surface 27b. The first surface 27a is subjected to the pressure of the fluid in the first upstream chamber 24. The second surface 27b is subjected to the pressure of the fluid in the first downstream chamber 25. In the closed state, the second flexible membrane 27 is preferably in a flat state without being bent. In the closed state, the second flexible membrane 27 may be in a slightly bent state. The bending amount of the second flexible membrane 27 when the first open and close section 28 is in the closed state indicated by solid line in FIG. 2 may be smaller than the bending amount of the second flexible membrane 27 when the first open and close section 28 is in the open state indicated by two-dot chain line in FIG. 2.

The first open and close section 28 may include a first shaft section 35, which is an example of a shaft section, and a first valve section 36, which is an example of a valve section. The first valve section 36 may include a first seal section 37, which is an example of a seal section. The first open and close section 28 can open and close the first communication port 32.

The first shaft section 35 is provided across the first upstream chamber 24 and the first downstream chamber 25. The first shaft section 35 is inserted into the second flexible membrane 27. The longitudinal direction of the first shaft section 35 may be parallel to the first direction D1. The first shaft section 35 may be rod-shaped. The first shaft section 35 may be cylindrical. The diameter of the first shaft section 35 is smaller than the inner diameter of the first communication port 32.

The first shaft section 35 is movable following the displacement of the first flexible membrane 26 and the second flexible membrane 27. The first shaft section 35 is fixed to the first flexible membrane 26 and to the second flexible membrane 27 directly or via a fixing member. One end of the first shaft section 35 is connected to the first flexible membrane 26. The other end of the first shaft section 35 is connected to the first valve section 36. The first shaft section 35 displaces the second flexible membrane 27 and the first valve section 36 by moving following the displacement of the first flexible membrane 26.

The first valve section 36 is connected to the first shaft section 35. The first valve section 36 can open and close the first communication port 32. The first valve section 36 can restrict the flow of the fluid from the first upstream chamber 24 toward the first downstream chamber 25. The first valve section 36 moves together with the first shaft section 35. When the first open and close section 28 is in the closed position indicated by solid line in FIG. 2, the first valve section 36 blocks communication between the first upstream chamber 24 and the first downstream chamber 25. When the first open and close section 28 is in the open position indicated by two-dot chain line in FIG. 2, the first valve section 36 enables communication between the first upstream chamber 24 and the first downstream chamber 25.

The first seal section 37 can intimately contact the first communication port 32. The first seal section 37 forms an outer periphery of the first valve section 36. The first seal section 37 may be annular. The first seal section 37 may be a toroidal O-ring. The first biasing section 29 biases the first flexible membrane 26 in the first direction D1 in which the volume of the first downstream chamber 25 decreases. The first biasing section 29 is provided outside the first downstream chamber 25. The first biasing section 29 presses the first open and close section 28 via the first flexible membrane 26. The first biasing section 29 is, for example, a compression spring.

### Operation of the Pressure Adjustment Valve

The pressure adjustment valve 21 reduces the pressure of the fluid flowing into the first upstream chamber 24 and causes the fluid to flow out from the first downstream chamber 25. The pressure of the fluid flowing out from the first downstream chamber 25 is a positive pressure. The pressure of the fluid flowing into the first upstream chamber 24 is a positive pressure higher than the pressure of the fluid flowing out of the first downstream chamber 25.

The first open and close section 28 moves in accordance with fluctuation in the pressure in the first downstream chamber 25. When the positive pressure in the first downstream chamber 25 decreases, the first flexible membrane 26 is displaced in a direction in which the volume of the first downstream chamber 25 is decreased by the biasing force of first biasing section 29. The first open and close section 28 moves by being pushed by the first flexible membrane 26. The second flexible membrane 27 is displaced along with the first open and close section 28. The second flexible membrane 27 is displaced in a direction in which the volume of the first upstream chamber 24 is decreased and the volume of the first downstream chamber 25 is increased. The second flexible membrane 27 mitigates changes in the volume of the first downstream chamber 25 that accompany displacement of the first flexible membrane 26.

The first open and close section 28 is pushed by the first flexible membrane 26 to move to the open position. Therefore, the first upstream chamber 24 is brought into communication with the first downstream chamber 25. The fluid is supplied from the first upstream chamber 24 to the first downstream chamber 25.

When the positive pressure in the first downstream chamber 25 increases, the first flexible membrane 26 is pushed by the fluid in the first downstream chamber 25 and is displaced in a direction in which the volume of the first downstream chamber 25 increases. The first open and close section 28 and the second flexible membrane 27 move to the closed position together with the first flexible membrane 26. Therefore, the supply of the fluid from the first upstream chamber 24 to the first downstream chamber 25 is stopped.

In the first upstream chamber 24, the pressure receiving area of the first valve section 36 may be the same as the pressure receiving area of the second flexible membrane 27. The area where the first valve section 36 contacts the fluid in the first upstream chamber 24 may be substantially the same as the area where the second flexible membrane 27 contacts the fluid in the first upstream chamber 24. In this case, even when the pressure in the first upstream chamber 24 increases, the first open and close section 28 does not move from the closed position.

### Pressure Release Valve

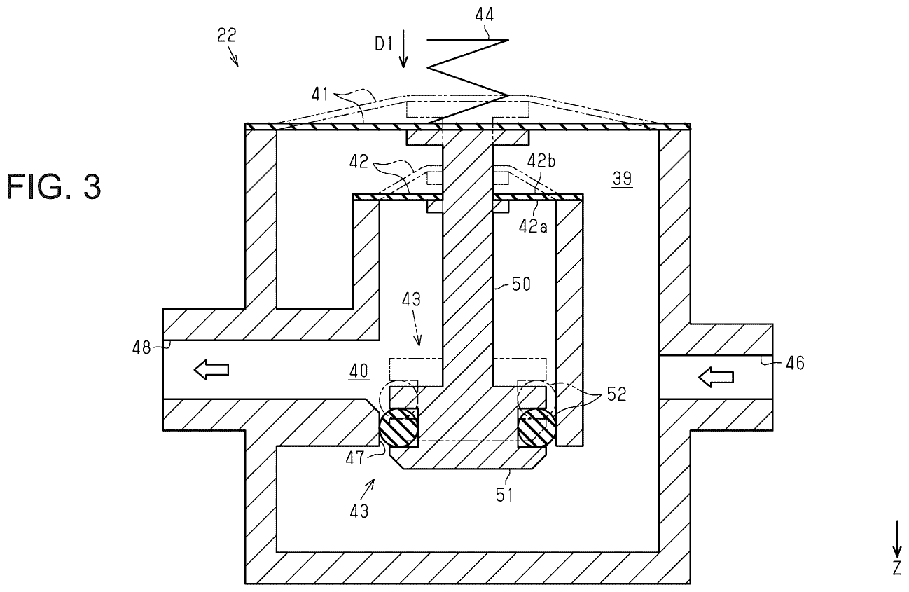

As shown in FIG. 3, the pressure release valve 22 includes a third upstream chamber 39 and a third downstream chamber 40. The third upstream chamber 39 includes a fifth flexible membrane 41. The pressure release valve 22 includes a sixth flexible membrane 42, a third open and close section 43, and a third biasing section 44. The third open and close section 43 is movable between a closed position indicated by solid line in FIG. 3 and an open position indicated by two-dot chain line in FIG. 3. In the present embodiment, a state where the third open and close section 43 is located at the closed position is also referred to as a closed state, and a state where the third open and close section 43 is located at the open position is also referred to as an open state.

The third upstream chamber 39 has a third inflow port 46 into which fluid flows. The third inflow port 46 of the present embodiment is connected to the liquid storage section 17 via the gas flow path 18. The fluid flows into the third upstream chamber 39 via the third inflow port 46. The fluid handled by the pressure release valve 22 of the present embodiment is a gas.

The third downstream chamber 40 is provided downstream of the third upstream chamber 39. The third downstream chamber 40 communicates with the third upstream chamber 39 via the third communication port 47 on the downstream side of the third upstream chamber 39. The third downstream chamber 40 has a third outflow port 48 through which the fluid flows out. The third outflow port 48 of the present embodiment communicates with atmosphere via the gas flow path 18. The third outflow port 48 may be opened directly to atmosphere.

The fifth flexible membrane 41 forms a part of the wall of the third upstream chamber 39. The fifth flexible membrane 41 is formed of a flexible member having flexibility, such as a diaphragm. The fifth flexible membrane 41 is displaced according to a difference in pressures applied to the outer surface and the inner surface. The total of the atmospheric pressure and the biasing force of third biasing section 44 is applied to the outer surface of the fifth flexible membrane 41. The pressure of the fluid in the third upstream chamber 39 is applied to the inner surface of the fifth flexible membrane 41. The fifth flexible membrane 41 in the closed state indicated by solid line in FIG. 3 bends slightly. In the closed state, it is desirable that the fifth flexible membrane 41 is in a flat state without bending. In the closed state, the fifth flexible membrane 41 may be in a slightly bent state. The bending amount of the fifth flexible membrane 41 when the third open and close section 43 is in the closed state indicated by solid line in FIG. 3 may be smaller than the bending amount of the fifth flexible membrane 41 when the third open and close section 43 is in the open state indicated by two-dot chain line in FIG. 3.

The sixth flexible membrane 42 partitions the third upstream chamber 39 and the third downstream chamber 40 from each other. The sixth flexible membrane 42 may be located above the third communication port 47. The sixth flexible membrane 42 is positioned between the third communication port 47 and the fifth flexible membrane 41. The third biasing section 44, the fifth flexible membrane 41, the sixth flexible membrane 42, and the third communication port 47 may be arranged in this order in the first direction D1.

The sixth flexible membrane 42 is displaced according to the difference between the pressures applied to a fifth surface 42a and a sixth surface 42b. The fifth surface 42a is subjected to the pressure of the fluid in the third downstream chamber 40. The sixth surface 42b is subjected to the pressure of the fluid in the third upstream chamber 39. In the closed state, it is desirable that the sixth flexible membrane 42 is in a flat state without bending. In the closed state, the sixth flexible membrane 42 may be in a slightly bent state. The bending amount of the sixth flexible membrane 42 when the third open and close section 43 is in the closed state indicated by solid line in FIG. 3 may be smaller than the bending amount of the sixth flexible membrane 42 when the third open and close section 43 is in the open state indicated by two-dot chain line in FIG. 3.

The third open and close section 43 may include a third shaft section 50 and a third valve section 51. The third valve section 51 may include a third seal section 52. The third open and close section 43 can open and close the third communication port 47.

The third shaft section 50 is provided across the third upstream chamber 39 and the third downstream chamber 40. The third shaft section 50 is inserted into the sixth flexible membrane 42. The longitudinal direction of the third shaft section 50 may be parallel to the first direction D1. The third shaft section 50 may be rod-shaped. The third shaft section 50 may be cylindrical. The diameter of the third shaft section 50 is smaller than the inner diameter of the third communication port 47.

The third shaft section 50 is movable following the displacement of the fifth flexible membrane 41 and the sixth flexible membrane 42. The third shaft section 50 is fixed to the fifth flexible membrane 41 and to the sixth flexible membrane 42 directly or via a fixing member. One end of the third shaft section 50 is connected to the fifth flexible membrane 41. The other end of the third shaft section 50 is connected to the third valve section 51. The third shaft section 50 displaces the sixth flexible membrane 42 and the third valve section 51 by moving following the displacement of the fifth flexible membrane 41.

The third valve section 51 is connected to the third shaft section 50. The third valve section 51 can open and close the third communication port 47. The third valve section 51 can restrict the flow of the fluid from the third upstream chamber 39 toward the third downstream chamber 40. The third valve section 51 moves together with the third shaft section 50. When the third open and close section 43 is in the closed position indicated by solid line in FIG. 3, the third valve section 51 blocks communication between the third upstream chamber 39 and the third downstream chamber 40. When the third open and close section 43 is in the open position indicated by two-dot chain line in FIG. 3, the third valve section 51 brings the third upstream chamber 39 and the third downstream chamber 40 into communication with each other.

The third seal section 52 can intimately contact the third communication port 47. The third seal section 52 forms the outer periphery of the third valve section 51. The third seal section 52 may be annular. The third seal section 52 may be a toroidal O-ring.

The third biasing section 44 biases the fifth flexible membrane 41 in the first direction D1 in which the volume of the third upstream chamber 39 decreases. The third biasing section 44 is provided outside the third upstream chamber 39. The third biasing section 44 presses the third open and close section 43 via the fifth flexible membrane 41. The third biasing section 44 is, for example, a compression spring.

### Operation of the Pressure Release Valve

The pressure release valve 22 reduces the pressure of the fluid flowing into the third upstream chamber 39 and causes the fluid to flow out from the third downstream chamber 40. The pressure of the fluid flowing into the third upstream chamber 39 is a positive pressure. The pressure of the fluid flowing out from the third downstream chamber 40 is lower than the pressure of the fluid flowing into the third upstream chamber 39. The pressure in the third downstream chamber 40 may be negative pressure, atmospheric pressure, or positive pressure.

The third open and close section 43 moves in accordance with fluctuation of the pressure in the third upstream chamber 39. When the positive pressure in the third upstream chamber 39 increases, the fifth flexible membrane 41 is displaced against the biasing force of the third biasing section 44, in a direction in which the volume of the third upstream chamber 39 increases. The third open and close section 43 moves by being pulled by the fifth flexible membrane 41. The sixth flexible membrane 42 is displaced along with the third open and close section 43. The sixth flexible membrane 42 is displaced in a direction in which the volume of the third upstream chamber 39 is decreased and the volume of the third downstream chamber 40 is increased. The sixth flexible membrane 42 mitigates changes in the volume of the third upstream chamber 39 that accompany displacement of the fifth flexible membrane 41.

The third open and close section 43 is pulled by the fifth flexible membrane 41 and moves to the open position. Therefore, the third upstream chamber 39 is brought into communication with the third downstream chamber 40. The fluid flows out from the third upstream chamber 39 to the third downstream chamber 40.

When the positive pressure in the third upstream chamber 39 decreases, the fifth flexible membrane 41 is pressed by the third biasing section 44 and is displaced in a direction in which the volume of the third upstream chamber 39 decreases. The third open and close section 43 and the sixth flexible membrane 42 move to the closed position together with the fifth flexible membrane 41. Therefore, the outflow of the fluid from the third upstream chamber 39 to the third downstream chamber 40 is stopped.

In the third downstream chamber 40, the pressure receiving area of the third valve section 51 may be the same as the pressure receiving area of the sixth flexible membrane 42. The area where the third valve section 51 contacts fluid in the third downstream chamber 40 may be substantially the same as the area where the sixth flexible membrane 42 contacts fluid in the third downstream chamber 40. In this case, even if the pressure in the third downstream chamber 40 changes, the third open and close section 43 does not move from the closed position.

### Operation of the First Embodiment

The operation of the present embodiment will be explained.

The pressurizing pump 20 pressurizes the inside of the liquid storage section 17. When the pressure in the liquid storage section 17 increases, the pressure release valve 22 releases the pressure in the liquid storage section 17. The pressure in the liquid ejection section 12 decreases, for example, by ejection of the liquid. When the pressure of the liquid ejection section 12 decreases, the pressure adjustment valve 21 allows the liquid to flow from the liquid storage section 17 to the liquid ejection section 12.

### Effects of First Embodiment

Effects of the present embodiment will be described.

(1-1) The pressure of the first upstream chamber 24 operates on the second flexible membrane 27 and the first valve section 36. The pressure in the first upstream chamber 24 that operates on the first valve section 36 and the pressure in the first upstream chamber 24 that operates on the second flexible membrane 27 cancel each other out. Therefore, it is possible to open and close the first open and close section 28 by the fluctuation of the pressure in the first downstream chamber 25. Therefore, variation in the pressure of the fluid can be reduced.

(1-2) One end of the first shaft section 35 is connected to the first flexible membrane 26, and the other end is connected to the first valve section 36. Therefore, for example, compared to a case where the first flexible membrane 26 and the first valve section 36 are connected to an intermediate section of the first shaft section 35, it is possible to miniaturize the pressure adjustment valve 21.

(1-3) The first valve section 36 has the first seal section 37. The first seal section 37 can intimately contact the first communication port 32. Therefore, it is possible to enhance the sealing property of the first communication port 32. (1-4) The first flexible membrane 26 and the second flexible membrane 27, which are bent by receiving force, attempt to return to a state in which the bending is minimal. In this regard, the bending amount of the first flexible membrane 26 and the second flexible membrane 27 is small when the first open and close section 28 is in the closed state. Therefore, it is possible to stabilize the states of the first flexible membrane 26 and the second flexible membrane 27 in the closed state of the first open and close section 28.

(1-5) The same pressure is applied to the second flexible membrane 27 and the first valve section 36. Therefore, by equalizing the pressure receiving areas of the second flexible membrane 27 and the first valve section 36, it is possible to easily cancel out the forces applied to the second flexible membrane 27 and the first valve section 36.

(1-6) The pressure adjustment valve 21 is provided in the liquid flow path 19 on the upstream side of the liquid ejection section 12. For this reason, it is possible to accurately adjust the pressure of the liquid that flows into the liquid ejection section 12.

### Second Embodiment

Next, a second embodiment of the valve mechanism, the liquid fluid device, and the liquid ejection device will be described with reference to the drawings. The liquid fluid device of the second embodiment is different from that of the first embodiment. In other respects, the second embodiment is substantially the same as the first embodiment, so the same components are denoted by the same reference numerals, and redundant description thereof will be omitted.

### Liquid Fluid Device

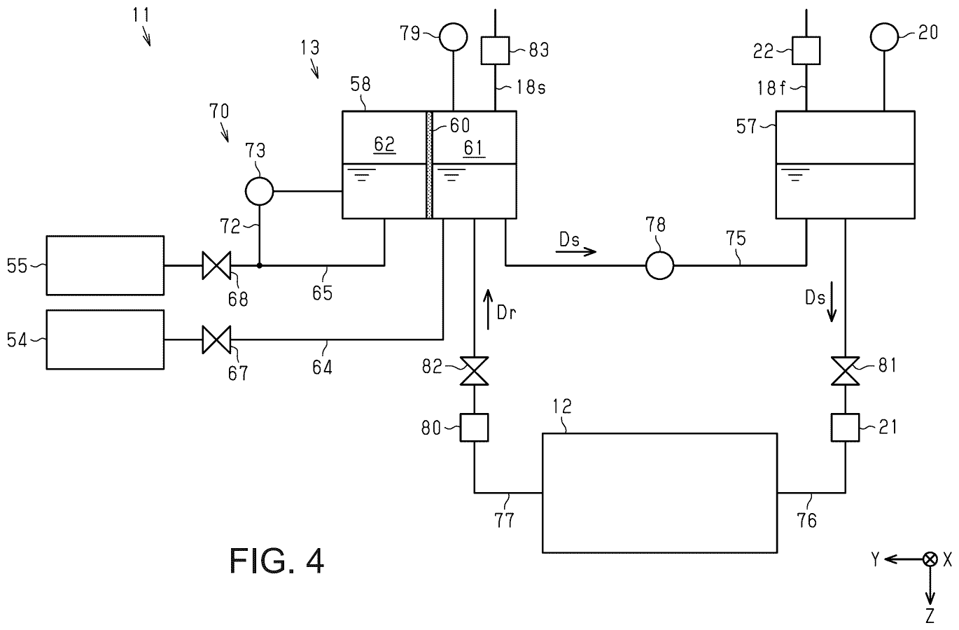

As shown in FIG. 4, the liquid fluid device 13 may cause humectant liquid to flow in addition to causing the liquid to flow. A humectant liquid is a liquid for moisturizing the liquid. The humectant liquid is, for example, a glycerin aqueous solution.

The liquid fluid device 13 may be connected to a liquid supply source 54 and a moisture supply source 55. The moisture supply source 55 contains moisture, namely water. The moisture supply source 55 may be a cartridge, a pack, or the like that is attachable to and detachable from the liquid ejection device 11, or may be a tank that can be replenished with liquid.

The liquid fluid device 13 may include a first tank 57, which is an example of a liquid storage section, and a second tank 58, which is also an example of a liquid storage section. The first tank 57 can store the liquid to be supplied to the liquid ejection section 12. The second tank 58 can store the liquid recovered from the liquid ejection section 12.

The second tank 58 may have a moisture permeable membrane 60. The moisture permeable membrane 60 partitions the inside of the second tank 58 into a liquid chamber 61 and a humectant liquid chamber 62. The liquid chamber 61 can accommodate liquid. Liquid is supplied to liquid chamber 61 from the liquid supply source 54. The humectant liquid chamber 62 can contain a humectant liquid. The humectant liquid chamber 62 is supplied with moisture from the moisture supply source 55.

The moisture permeable membrane 60 is a membrane that allows gases to pass through while preventing liquids from passing through. Therefore, the moisture permeable membrane 60 partitions the liquid and the humectant liquid from each other so that the liquid stored in the liquid chamber 61 and the humectant liquid stored in the humectant liquid chamber 62 do not mix together. The moisture permeable membrane 60 is a porous membrane in which a plurality of pores are formed. A meniscus is generated in the pores by surface tension of the liquid. As a result, the moisture permeable membrane 60 allows gas to permeate through it, while preventing the permeation of liquids. The humectant liquid moisturizes the liquid by supplying moisture to the liquid through the moisture permeable membrane 60.

The liquid fluid device 13 may include a liquid supply flow path 64 and a moisture supply flow path 65. The liquid supply flow path 64 is connected to the liquid supply source 54 and the liquid chamber 61. The moisture supply flow path 65 is connected to the moisture supply source 55 and the humectant liquid chamber 62.

The liquid fluid device 13 may include a liquid supply valve 67 and a moisture supply valve 68. The liquid supply valve 67 is positioned in the liquid supply flow path 64. When the liquid supply valve 67 is opened, the liquid can be supplied from the liquid supply source 54 to the second tank 58. The moisture supply valve 68 is positioned in the moisture supply flow path 65. When the moisture supply valve 68 is opened, moisture can be supplied from the moisture supply source 55 to the second tank 58. Normally, the liquid supply valve 67 and the moisture supply valve 68 are closed. The liquid supply valve 67 is opened when it is necessary to supply the liquid to the second tank 58. The moisture supply valve 68 is opened when it is necessary to supply moisture to the second tank 58.

The liquid fluid device 13 may include an agitation section 70. The agitation section 70 is attached to the second tank 58. The agitation section 70 agitates the humectant liquid stored in the humectant liquid chamber 62. The concentration of the humectant liquid is made uniform by the agitation section 70 agitating the humectant liquid. Accordingly, a concern that the concentration of the humectant liquid will increase is reduced.

The agitation section 70 may include an agitation flow path 72 and an agitation pump 73. The agitation flow path 72 is connected to the humectant liquid chamber 62 and the moisture supply flow path 65. The agitation pump 73 is located in the agitation flow path 72. The agitation pump 73 circulates the humectant liquid in the second tank 58 through the agitation flow path 72. Accordingly, the humectant liquid is agitated.

The liquid fluid device 13 may include a connection flow path 75, a positive pressure flow path 76, which is an example of a liquid flow path and a first liquid flow path, a negative pressure flow path 77, which is an example of a liquid flow path and a second liquid flow path, a first gas flow path 18f, and a second gas flow path 18s. The liquid fluid device 13 may include a liquid feed section 78, a pressurizing pump 20, and a pressure reduction pump 79, which is an example of a pressure varying mechanism. The liquid fluid device 13 may include a pressure adjustment valve 21, a pressure release valve 22, a negative pressure adjustment valve 80, which is an example of a valve mechanism and a second valve mechanism, an upstream valve 81, a downstream valve 82, and a negative pressure release valve 83.

### Negative Pressure Adjustment Valve

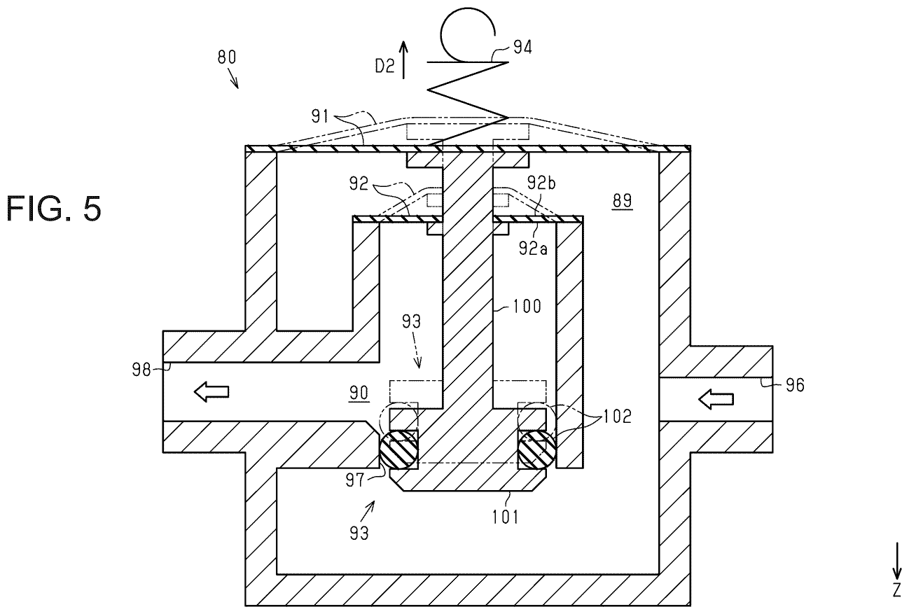

As shown in FIG. 5, the negative pressure adjustment valve 80 includes a second upstream chamber 89, which is an example of an upstream chamber, and a second downstream chamber 90, which is an example of a downstream chamber. The second upstream chamber 89 includes a third flexible membrane 91, which is an example of a first flexible membrane. The negative pressure adjustment valve 80 includes a fourth flexible membrane 92, which is an example of a second flexible membrane, a second open and close section 93, which is an example of an open and close section, and a second biasing section 94, which is an example of a biasing section. The second open and close section 93 is movable between a closed position indicated by solid line in FIG. 5 and an open position indicated by two-dot chain line in FIG. 5. In the present embodiment, a state where the second open and close section 93 is located at the closed position is also referred to as a closed state, and a state where the second open and close section 93 is located at the open position is also referred to as an open state.

The second upstream chamber 89 has a second inflow port 96, which is an example of an inflow port in through which fluid flows. The second inflow port 96 of the present embodiment is connected to the liquid ejection section 12 via the negative pressure flow path 77. The fluid flows into the second upstream chamber 89 via the second inflow port 96. The fluid handled by the negative pressure adjustment valve 80 of the present embodiment is a liquid.

The second downstream chamber 90 is provided downstream of the second upstream chamber 89. Downstream of the second upstream chamber 89, the second downstream chamber 90 communicates with the second upstream chamber 89 via the second communication port 97, which is an example of a communication port. The second downstream chamber 90 has a second outflow port 98 out through which the fluid flows. The second outflow port 98 of the present embodiment communicates with the second tank 58 via the negative pressure flow path 77.

The third flexible membrane 91 forms a part of the wall of the second upstream chamber 89. The third flexible membrane 91 is formed of a flexible member with flexibility, such as a diaphragm. The third flexible membrane 91 is displaced according to differences in pressure applied to the outer surface and the inner surface. A differential pressure between atmospheric pressure and the biasing force of the second biasing section 94 is applied to the outer surface of the third flexible membrane 91. The pressure of the fluid in the second upstream chamber 89 is applied to the inner surface of the third flexible membrane 91. In the closed state indicated by solid line in FIG. 5, the third flexible membrane 91 bends slightly. In the closed state, it is desirable that the third flexible membrane 91 is in a flat state without bending. In the closed state, the third flexible membrane 91 may be in a slightly bent state. The bending amount of the third flexible membrane 91 when the second open and close section 93 is in the closed state indicated by solid line in FIG. 5 may be smaller than the bending amount of the third flexible membrane 91 when the second open and close section 93 is in the open state indicated by two-dot chain line in FIG. 5.

The fourth flexible membrane 92 partitions the second upstream chamber 89 and the second downstream chamber 90. The fourth flexible membrane 92 may be located above the second communication port 97. The fourth flexible membrane 92 is positioned between the second communication port 97 and the third flexible membrane 91. The second communication port 97, the fourth flexible membrane 92, the third flexible membrane 91, and the second biasing section 94 may be arranged in this order in the second direction D2. The second direction D2 may be a direction opposite to the vertical direction Z.

The fourth flexible membrane 92 is displaced according to the difference between the pressures applied to the third surface 92a and the fourth surface 92b. The pressure of the fluid in the second downstream chamber 90 is applied to the third surface 92a. The pressure of the fluid in the second upstream chamber 89 is applied to the fourth surface 92b. In the closed state, it is desirable that the fourth flexible membrane 92 is in a flat state without bending. In the closed state, the fourth flexible membrane 92 may be in a slightly bent state. The bending amount of the fourth flexible membrane 92 when the second open and close section 93 is in the closed state indicated by solid line in FIG. 5 may be smaller than the bending amount of the fourth flexible membrane 92 when the second open and close section 93 is in the open state indicated by two-dot chain line in FIG. 5.

The second open and close section 93 may include a second shaft section 100, which is an example of a shaft section, and a second valve section 101, which is an example of a valve section. The second valve section 101 may include a second seal section 102, which is an example of a seal section. The second open and close section 93 can open and close the second communication port 97.

The second shaft section 100 is provided across the second upstream chamber 89 and the second downstream chamber 90. The second shaft section 100 is inserted into the fourth flexible membrane 92. The longitudinal direction of the second shaft section 100 may be parallel to the second direction D2. The second shaft section 100 may be rod-shaped. The second shaft section 100 may be cylindrical. The diameter of the second shaft section 100 is smaller than the inner diameter of the second communication port 97.

The second shaft section 100 is movable following displacement of the third flexible membrane 91 and the fourth flexible membrane 92. The second shaft section 100 is fixed to the third flexible membrane 91 and to the fourth flexible membrane 92 directly or via a fixing member. One end of the second shaft section 100 is connected to the third flexible membrane 91. The other end of the second shaft section 100 is connected to the second valve section 101. The second shaft section 100 displaces the fourth flexible membrane 92 and the second valve section 101 by moving following displacement of the third flexible membrane 91.

The second valve section 101 is connected to the second shaft section 100. The second valve section 101 can open and close the second communication port 97. The second valve section 101 can restrict the flow of fluid from the second upstream chamber 89 toward the second downstream chamber 90. The second valve section 101 moves together with the second shaft section 100. When the second open and close section 93 is in the closed position indicated by solid line in FIG. 5, the second valve section 101 blocks communication between the second upstream chamber 89 and the second downstream chamber 90. When the second open and close section 93 is in the open position indicated by two-dot chain line in FIG. 5, the second valve section 101 brings the second upstream chamber 89 and the second downstream chamber 90 into communication with each other.

The second seal section 102 can intimately contact the second communication port 97. The second seal section 102 forms the outer periphery of the second valve section 101. The second seal section 102 may be annular. The second seal section 102 may be a toroidal O-ring.

The second biasing section 94 biases the third flexible membrane 91 in the second direction D2 in which the volume of the second upstream chamber 89 increases. The second biasing section 94 is provided outside the second upstream chamber 89. The second biasing section 94 pulls the second open and close section 93 via the third flexible membrane 91. The second biasing section 94 is, for example, a tension spring.

### Operation of the Negative Pressure Adjustment Valve

The negative pressure adjustment valve 80 mitigates the negative pressure of the fluid operating on the second downstream chamber 90 and applies it to the second upstream chamber 89. The pressure of the fluid flowing into the second upstream chamber 89 is negative. The pressure of the fluid flowing out from the second downstream chamber 90 is a negative pressure lower than the pressure of the fluid flowing into the second upstream chamber 89.

The second open and close section 93 moves in accordance with the fluctuation of the pressure in the second upstream chamber 89. When the negative pressure in the second upstream chamber 89 decreases, the third flexible membrane 91 is displaced in a direction in which the volume of the second upstream chamber 89 is increased by the biasing force of the second biasing section 94. The second open and close section 93 moves by being pulled by the third flexible membrane 91. The fourth flexible membrane 92 is displaced along with the second open and close section 93. The fourth flexible membrane 92 is displaced in a direction in which the volume of the second upstream chamber 89 is decreased and the volume of the second downstream chamber 90 is increased. The fourth flexible membrane 92 mitigates changes in the volume of the second upstream chamber 89 that accompany displacement of the third flexible membrane 91.

The second open and close section 93 is pulled by the third flexible membrane 91 and moves to the open position. Therefore, the second upstream chamber 89 is brought into communication with the second downstream chamber 90. The fluid flows out from the second upstream chamber 89 to the second downstream chamber 90.

When the negative pressure in the second upstream chamber 89 increases, the third flexible membrane 91 is displaced in a direction in which the volume of the second upstream chamber 89 is decreased against the biasing force of the second biasing section 94. The second open and close section 93 and the fourth flexible membrane 92 move to the closed position together with the third flexible membrane 91. Therefore, the outflow of the fluid from the second upstream chamber 89 to the second downstream chamber 90 is stopped.

In the second downstream chamber 90, the pressure receiving area of the second valve section 101 may be the same as the pressure receiving area of the fourth flexible membrane 92. The area where the second valve section 101 contacts fluid in the second downstream chamber 90 may be substantially the same as the area where the fourth flexible membrane 92 contacts fluid in the second downstream chamber 90. In this case, even if the pressure in the second downstream chamber 90 changes, the second open and close section 93 does not move from the closed position.

### Negative Pressure Release Valve

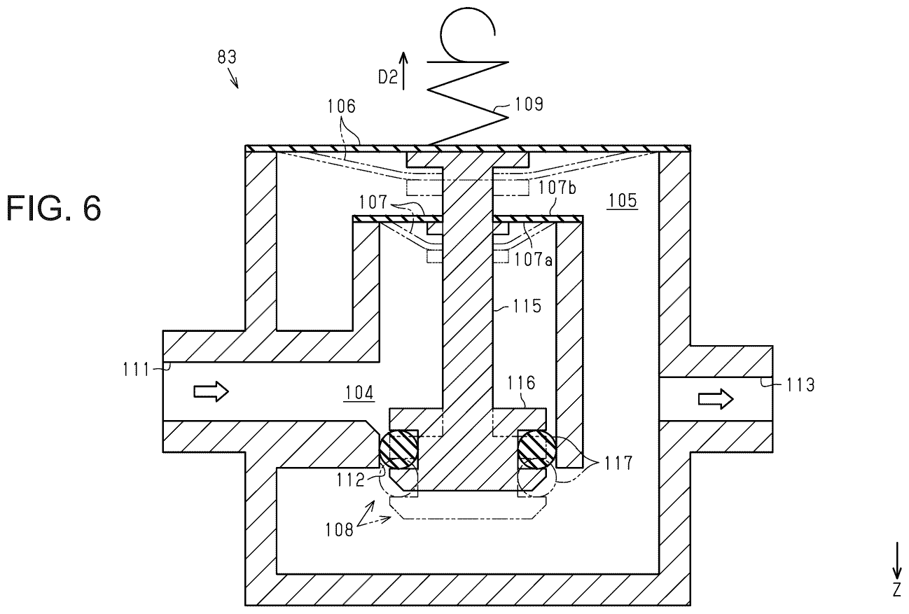

As shown in FIG. 6, the negative pressure release valve 83 includes a fourth upstream chamber 104 and a fourth downstream chamber 105. The fourth downstream chamber 105 has a seventh flexible membrane 106. The negative pressure release valve 83 includes an eighth flexible membrane 107, a fourth open and close section 108, and a fourth biasing section 109. The fourth open and close section 108 is movable between a closed position indicated by solid line in FIG. 6 and an open position indicated by two-dot chain line in FIG. 6. In the present embodiment, a state in which the fourth open and close section 108 is located at the closed position is also referred to as a closed state, and a state in which the fourth open and close section 108 is located at the open position is also referred to as an open state. In FIG. 6, the direction in which the fluid flows is indicated by white arrows.

The fourth upstream chamber 104 has a fourth inflow port 111. The fourth inflow port 111 of the present embodiment communicates with atmosphere via the second gas flow path 18s. The fluid flows into the fourth upstream chamber 104 via the fourth inflow port 111. The fluid handled by the negative pressure release valve 83 of the present embodiment is a gas.

The fourth downstream chamber 105 is provided downstream of the fourth upstream chamber 104. The fourth downstream chamber 105 is in communication with the fourth upstream chamber 104 via the fourth communication port 112 downstream of the fourth upstream chamber 104. The fourth downstream chamber 105 has a fourth outflow port 113 through which the fluid flows out. The fourth outflow port 113 of the present embodiment communicates with the second tank 58 via the second gas flow path 18s.

The seventh flexible membrane 106 forms a part of a wall of the fourth downstream chamber 105. The seventh flexible membrane 106 is formed of a flexible member having flexibility such as a diaphragm. The seventh flexible membrane 106 is displaced according to differences in pressure applied to the outer surface and the inner surface. A differential pressure between atmospheric pressure and the biasing force of the fourth biasing section 109 is applied to the outer surface of the seventh flexible membrane 106. The pressure of the fluid in the fourth downstream chamber 105 is applied to the inner surface of the seventh flexible membrane 106. The seventh flexible membrane 106 in the closed state indicated by solid line in FIG. 6 is slightly bent. In the closed state, the seventh flexible membrane 106 is preferably in a flat state without being bent. In the closed state, the seventh flexible membrane 106 may be in a slightly bent state. The bending amount of the seventh flexible membrane 106 when the fourth open and close section 108 is in the closed state indicated by solid line in FIG. 6 may be smaller than the bending amount of the seventh flexible membrane 106 when the fourth open and close section 108 is in the open state indicated by two-dot chain line in FIG. 6.

The eighth flexible membrane 107 partitions the fourth upstream chamber 104 and the fourth downstream chamber 105. The eighth flexible membrane 107 may be located above the fourth communication port 112. The eighth flexible membrane 107 is positioned between the fourth communication port 112 and the seventh flexible membrane 106. The fourth communication port 112, the eighth flexible membrane 107, the seventh flexible membrane 106, and the fourth biasing section 109 may be arranged in this order in the second direction D2. The second direction D2 may be a direction opposite to the vertical direction Z.

The eighth flexible membrane 107 is displaced according to the difference between the pressures applied to the seventh surface 107a and the eighth surface 107b. The pressure of the fluid in the fourth upstream chamber 104 is applied to the seventh surface 107a. The pressure of the fluid in the fourth downstream chamber 105 is applied to the eighth surface 107b. In the closed state, it is desirable that the eighth flexible membrane 107 is in a flat state without bending. In the closed state, the eighth flexible membrane 107 may be in a slightly bent state. The bending amount of the eighth flexible membrane 107 when the fourth open and close section 108 is in the closed state indicated by solid line in FIG. 6 may be smaller than the bending amount of the eighth flexible membrane 107 when the fourth open and close section 108 is in the open state indicated by two-dot chain line in FIG. 6.

The fourth open and close section 108 may include a fourth shaft section 115 and a fourth valve section 116. The fourth valve section 116 may include a fourth seal section 117. The fourth open and close section 108 can open and close the fourth communication port 112.

The fourth shaft section 115 is provided across the fourth upstream chamber 104 and the fourth downstream chamber 105. The fourth shaft section 115 is inserted into the eighth flexible membrane 107. The longitudinal direction of the fourth shaft section 115 may be parallel to second direction D2. The fourth shaft section 115 may be rod-shaped. The fourth shaft section 115 may have a cylindrical shape. The diameter of the fourth shaft section 115 is smaller than the inner diameter of the fourth communication port 112.

The fourth shaft section 115 is movable following displacement of the seventh flexible membrane 106 and the eighth flexible membrane 107. The fourth shaft section 115 is fixed to the seventh flexible membrane 106 and to the eighth flexible membrane 107 directly or via a fixing member. One end of the fourth shaft section 115 is connected to the seventh flexible membrane 106. The other end of the fourth shaft section 115 is connected to the fourth valve section 116. The fourth shaft section 115 displaces the eighth flexible membrane 107 and the fourth valve section 116 by moving following displacement of the seventh flexible membrane 106.

The fourth valve section 116 is connected to the fourth shaft section 115. The fourth valve section 116 can open and close the fourth communication port 112. The fourth valve section 116 can restrict the flow of fluid from the fourth upstream chamber 104 toward the fourth downstream chamber 105. The fourth valve section 116 moves together with the fourth shaft section 115. When the fourth open and close section 108 is in the closed position indicated by solid line in FIG. 6, the fourth valve section 116 blocks communication between the fourth upstream chamber 104 and the fourth downstream chamber 105. When the fourth open and close section 108 is in the open position indicated by two-dot chain line in FIG. 6, the fourth valve section 116 brings the fourth upstream chamber 104 and the fourth downstream chamber 105 into communication with each other.

The fourth seal section 117 can intimately contact the fourth communication port 112. The fourth seal section 117 forms the outer periphery of the fourth valve section 116. The fourth seal section 117 may be annular. The fourth seal section 117 may be a toroidal O-ring.

The fourth biasing section 109 biases the seventh flexible membrane 106 in the second direction D2 in which the volume of the fourth downstream chamber 105 increases. The fourth biasing section 109 is provided outside the fourth downstream chamber 105. The fourth biasing section 109 pulls the fourth open and close section 108 via the seventh flexible membrane 106. The fourth biasing section 109 is, for example, a tension spring.

### Operation of the Negative Pressure Release Valve.

The negative pressure release valve 83 reduces the pressure of the fluid flowing into the fourth upstream chamber 104 and causes the fluid to flow out from the fourth downstream chamber 105. The pressure of the fluid flowing out from the fourth downstream chamber 105 is negative. The pressure of the fluid flowing into the fourth upstream chamber 104 is a higher pressure than the pressure of the fluid flowing out of the fourth downstream chamber 105. The fluid flowing into the fourth upstream chamber 104 may have either a negative or a positive pressure.

The fourth open and close section 108 moves in accordance with fluctuation in the pressure in the fourth downstream chamber 105. When the negative pressure in the fourth downstream chamber 105 increases, the seventh flexible membrane 106 is displaced against the biasing force of the fourth biasing section 109, in a direction in which the volume of the fourth downstream chamber 105 decreases. The fourth open and close section 108 moves by being pushed by the seventh flexible membrane 106. The eighth flexible membrane 107 is displaced along with the fourth open and close section 108. The eighth flexible membrane 107 is displaced in a direction in which the volume of the fourth upstream chamber 104 is decreased and the volume of the fourth downstream chamber 105 is increased. The eighth flexible membrane 107 mitigates changes in the volume of the fourth downstream chamber 105 that accompany displacement of the seventh flexible membrane 106.

The fourth open and close section 108 is pushed by the seventh flexible membrane 106 to move to the open position. Therefore, the fourth upstream chamber 104 is brought into communication with the fourth downstream chamber 105. The fluid is supplied from the fourth upstream chamber 104 to the fourth downstream chamber 105.

When the negative pressure in the fourth downstream chamber 105 decreases, the seventh flexible membrane 106 is pulled by the fourth biasing section 109 and displaced in the direction in which the volume of the fourth downstream chamber 105 increases. The fourth open and close section 108 and the seventh flexible membrane 106 move to the closed position together with the seventh flexible membrane 106. Therefore, the supply of fluid from the fourth upstream chamber 104 to the fourth downstream chamber 105 is stopped.

In the fourth upstream chamber 104, the pressure receiving area of the fourth valve section 116 may be the same as the pressure receiving area of the eighth flexible membrane 107. The area where the fourth valve section 116 contacts the fluid in the fourth upstream chamber 104 may be substantially the same as the area where the eighth flexible membrane 107 contacts the fluid in the fourth upstream chamber 104. In this case, even when the pressure in the fourth upstream chamber 104 increases, the fourth open and close section 108 does not move from the closed position.

As shown in FIG. 4, the connection flow path 75 connects the second tank 58 and the first tank 57. The liquid feed section 78 is positioned in the connection flow path 75. The liquid feed section 78 sends liquid from the second tank 58 to the first tank 57 via the connection flow path 75. The liquid feed section 78 sends liquid in the supply direction Ds.

The positive pressure flow path 76 is connected to the first tank 57. The upstream end of positive pressure flow path 76 in the supply direction Ds is connected to the first tank 57. The positive pressure flow path 76 has its downstream end in the supply direction Ds connected to the liquid ejection section 12. The positive pressure flow path 76 brings the first tank 57 and the liquid ejection section 12 into communication with each other. The positive pressure flow path 76 connects the first tank 57 and the liquid ejection section 12 in a state in which liquid can flow. The positive pressure flow path 76 sends the liquid from the first tank 57 to the liquid ejection section 12.

The upstream valve 81 and the pressure adjustment valve 21 are provided in the positive pressure flow path 76. The pressure adjustment valve 21 is provided upstream of the liquid ejection section 12 in the supply direction Ds in the positive pressure flow path 76. The upstream valve 81 can open and close the positive pressure flow path 76. The pressure adjustment valve 21 is provided between the upstream valve 81 and the liquid ejection section 12. In the pressure adjustment valve 21 provided in the positive pressure flow path 76, the first inflow port 31 communicates with the first tank 57, and the first outflow port 33 communicates with the liquid ejection section 12. When the positive pressure on the liquid ejection section 12 side decreases, the pressure adjustment valve 21 enters an open state indicated by two-dot chain line in FIG. 2. When the pressure adjustment valve 21 is in the open state, the liquid is supplied from the first tank 57 to the liquid ejection section 12.

The negative pressure flow path 77 is connected to the second tank 58. The downstream end of the negative pressure flow path 77 in a collection direction Dr is connected to the second tank 58. The upstream end of the negative pressure flow path 77 in the collection direction Dr is connected to the liquid ejection section 12. The negative pressure flow path 77 brings the liquid ejection section 12 and the second tank 58 into communication with each other. The negative pressure flow path 77 connects the liquid ejection section 12 and the second tank 58 in a state in which the liquid can flow. The negative pressure flow path 77 sends the liquid collected from the liquid ejection section 12 to the second tank 58.

The downstream valve 82 and the negative pressure adjustment valve 80 are provided in the negative pressure flow path 77. The negative pressure adjustment valve 80 is provided in the negative pressure flow path 77 downstream of the liquid ejection section 12 in the collection direction Dr. The downstream valve 82 can open and close the negative pressure flow path 77. The negative pressure adjustment valve 80 adjusts the negative pressure on the liquid ejection section 12 side. The negative pressure adjustment valve 80 reduces the magnitude of the negative pressure on the liquid ejection section 12 side to be less than the magnitude of the negative pressure on the second tank 58 side. The pressure of the liquid recovered from the liquid ejection section 12 is adjusted by the negative pressure adjustment valve 80. Therefore, the negative pressure applied to the liquid ejection section 12 is smaller than the reduced negative pressure in the second tank 58.

The first gas flow path 18f is connected to the first tank 57. One end of the first gas flow path 18f is connected to the first tank 57, and the other end is open to atmosphere. Pressure release valve 22 is provided in the first gas flow path 18f. In the pressure release valve 22, the third inflow port 46 communicates with the first tank 57, and the third outflow port 48 is opened to atmosphere. The pressure release valve 22 is connected to the first tank 57. The pressure release valve 22 can adjust the pressure of the first tank 57.

The second gas flow path 18s is connected to the second tank 58. For example, one end of the second gas flow path 18s is connected to the liquid chamber 61, and the other end is open to atmosphere. The negative pressure release valve 83 is provided in the second gas flow path 18s. In the negative pressure release valve 83 provided in the second gas flow path 18s, the fourth inflow port 111 is open to atmosphere, and the fourth outflow port 113 is in communication with the liquid chamber 61. The negative pressure release valve 83 is connected to the second tank 58. The negative pressure release valve 83 can adjust the pressure of the second tank 58.

The pressurizing pump 20 can pressurize the inside of the first tank 57. The pressurizing pump 20 changes the pressure of the liquid flowing through the positive pressure flow path 76. The pressurizing pump 20 may pressurize the inside of the first tank 57 by sending air into the first tank 57. When the pressurizing pump 20 pressurizes the inside of the first tank 57, the liquid in the first tank 57 flows out to the positive pressure flow path 76. When the pressure in the first tank 57 exceeds a predetermined pressure, the pressure release valve 22 enters an open state to release the pressure in the first tank 57.

The pressure reduction pump 79 can reduce the pressure in the second tank 58. The pressure reduction pump 79 changes the pressure of the liquid flowing through the negative pressure flow path 77. The pressure reduction pump 79 may decompress the inside of the second tank 58 by drawing air from the inside of the second tank 58. The pressure reduction pump 79 normally depressurizes the inside of the second tank 58 so that the inside of the liquid ejection section 12 is maintained at a predetermined negative pressure. When the negative pressure in the second tank 58 becomes larger than a predetermined negative pressure, the negative pressure release valve 83 enters the open state to allow air to flow into the first tank 57.

When the pressure reduction pump 79 reduces the pressure in the second tank 58, the liquid flows into the second tank 58. For example, when the pressure reduction pump 79 is driven while the liquid supply valve 67 is in an open state, the liquid flows from the liquid supply source 54 and into the second tank 58 through the liquid supply flow path 64. When the pressure reduction pump 79 is driven while the moisture supply valve 68 is in an open state, the liquid flows from the moisture supply source 55 into the second tank 58 through the moisture supply flow path 65. When the pressure reduction pump 79 is driven with the liquid supply valve 67 and the moisture supply valve 68 in a closed state, the liquid flows from the liquid ejection section 12 into the second tank 58 through the negative pressure flow path 77.

The connection flow path 75, the positive pressure flow path 76, and the negative pressure flow path 77 circulate the liquid and also supply the liquid to the liquid ejection section 12. When the liquid is circulated, it flows from the second tank 58 to the first tank 57 through the connection flow path 75. When the liquid is circulated, the liquid flows from the first tank 57 to the liquid ejection section 12 through the positive pressure flow path 76. When the liquid is circulated, the liquid flows from the liquid ejection section 12 to the second tank 58 through the negative pressure flow path 77. The positive pressure flow path 76 is a flow path for supplying liquid to the liquid ejection section 12. The negative pressure flow path 77 is a flow path for recovering the liquid from the liquid ejection section 12.

### Operation of Second Embodiment

The operation of the present embodiment will be explained.

The pressure of the liquid supplied from the first tank 57 to the liquid ejection section 12 is adjusted by the pressure adjustment valve 21. Therefore, the liquid having a pressure lower than the pressure in the pressurized first tank 57 is supplied to the liquid ejection section 12.

The pressure of the liquid recovered from the liquid ejection section 12 is adjusted by the negative pressure adjustment valve 80. Therefore, the negative pressure applied to the liquid ejection section 12 is smaller than the reduced negative pressure in the second tank 58.

### Effects of Second Embodiment

Effects of the present embodiment will be described.

(2-1) The pressure of the second downstream chamber 90 operates on the fourth flexible membrane 92 and the second valve section 101. The pressure of the second downstream chamber 90 that operates on the second valve section 101 and the pressure of the second downstream chamber 90 that operates on the fourth flexible membrane 92 cancel each other out. Therefore, it is possible to open and close the second open and close section 93 by fluctuation of the pressure of the second upstream chamber 89. Therefore, variation in the pressure of the fluid can be reduced.

(2-3) One end of the second shaft section 100 is connected to the third flexible membrane 91, and the other end thereof is connected to the second valve section 101. Therefore, for example, compared to a case where the third flexible membrane 91 and the second valve section 101 are connected to an intermediate section of the second shaft section 100, it is possible to miniaturize the negative pressure adjustment valve 80.

(2-3) The second valve section 101 has the second seal section 102. The second seal section 102 can intimately contact the second communication port 97. Therefore, it is possible to enhance the sealing property of the second communication port 97.

(2-4) The third flexible membrane 91 and the fourth flexible membrane 92, which are bent by receiving force, attempt to return to a state of slight bending. In this regard, the bending amount of the third flexible membrane 91 and the fourth flexible membrane 92 is small when the second open and close section 93 is in the closed state. Therefore, in the closed state of the second open and close section 93, it is possible to stabilize the third flexible membrane 91 and the state of the third flexible membrane 91.

(2-5) The same pressure is applied to the fourth flexible membrane 92 and the second valve section 101. Therefore, by equalizing the pressure receiving areas of the fourth flexible membrane 92 and the second valve section 101, it is possible to easily cancel out the forces applied to the fourth flexible membrane 92 and the second valve section 101.

(2-6) The negative pressure adjustment valve 80 is provided in the negative pressure flow path 77 downstream of the liquid ejection section 12. For this reason, it is possible to accurately adjust the pressure of the liquid that flows out from the liquid ejection section 12. (2-7) When the pressure in the first downstream chamber 25 decreases, the pressure adjustment valve 21 sets the first open and close section 28 to the open state. When the negative pressure in the second upstream chamber 89 decreases, the second open and close section 93 of the negative pressure adjustment valve 80 enters the open state. Therefore, by using the pressure adjustment valve 21 and the negative pressure adjustment valve 80 according to the pressure of the fluid, it is possible to stabilize the pressure of the positive pressure fluid and the negative pressure fluid.

(2-8) The pressure adjustment valve 21 is provided in the positive pressure flow path 76 on the upstream side of the liquid ejection section 12. The negative pressure adjustment valve 80 is provided in the negative pressure flow path 77 downstream of the liquid ejection section 12. Therefore, it is possible to accurately adjust the pressure of the liquid which flows into the liquid ejection section 12 and the pressure of the liquid which flows out from the liquid ejection section 12.

### Modifications

The present embodiment can be implemented with the following modifications. The embodiments and the following modifications can be implemented in combination with each other as long as there is no technical contradiction.

### First Modification

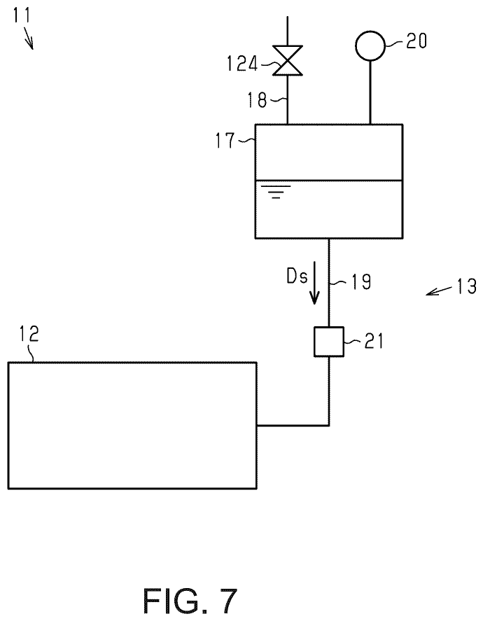

As shown in FIG. 7, the liquid ejection device 11 may include an atmosphere release valve 124. The atmosphere release valve 124 may be provided in the gas flow path 18. The atmosphere release valve 124 can open the inside of the liquid storage section 17 to atmosphere. The atmosphere release valve 124 can change the pressure applied to the liquid in the liquid storage section 17 to atmospheric pressure.

### Second Modification

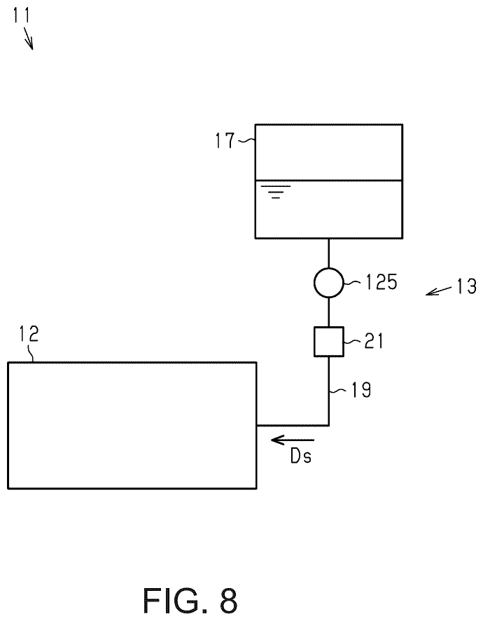

As shown in FIG. 8, the liquid ejection device 11 may include a liquid pump 125. The liquid pump 125 may be provided in the liquid flow path 19 between the liquid storage section 17 and the pressure adjustment valve 21. The liquid pump 125 causes the liquid in the liquid flow path 19 to flow in the supply direction Ds.

### Third Modification

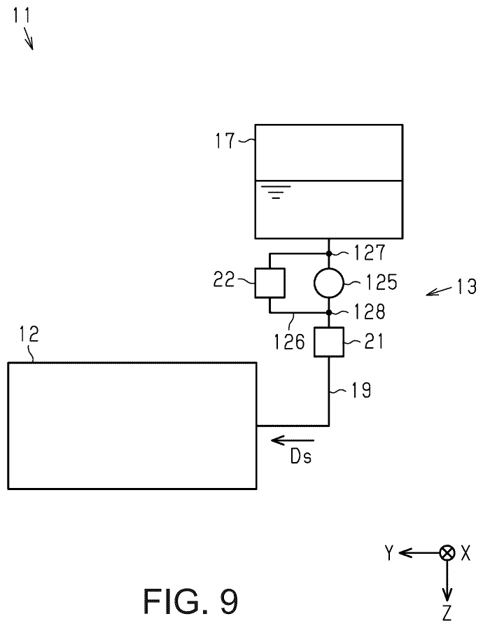

As shown in FIG. 9, the liquid ejection device 11 may include a relief flow path 126. The pressure release valve 22 may be provided in the relief flow path 126.

The relief flow path 126 connects a first connection section 127 and a second connection section 128 in the liquid flow path 19. The first connection section 127 is provided between the liquid storage section 17 and the liquid pump 125 in the supply direction Ds. The second connection section 128 is provided between the liquid pump 125 and the pressure adjustment valve 21 in the supply direction Ds. In the pressure release valve 22, the third inflow port 46 communicates with the second connection section 128 via the relief flow path 126. In the pressure release valve 22, the third outflow port 48 communicates with the first connection section 127 via the relief flow path 126.

When the pressure of the second connection section 128 becomes higher than a predetermined pressure, the pressure release valve 22 enters the open state shown in FIG. 3. When the pressure release valve 22 is in the open state, the liquid circulates in the liquid flow path 19 between the first connection section 127 and the second connection section 128 and the relief flow path 126. The pressure release valve 22 limits the pressure applied to the liquid in liquid flow path 19.

### Fourth Modification

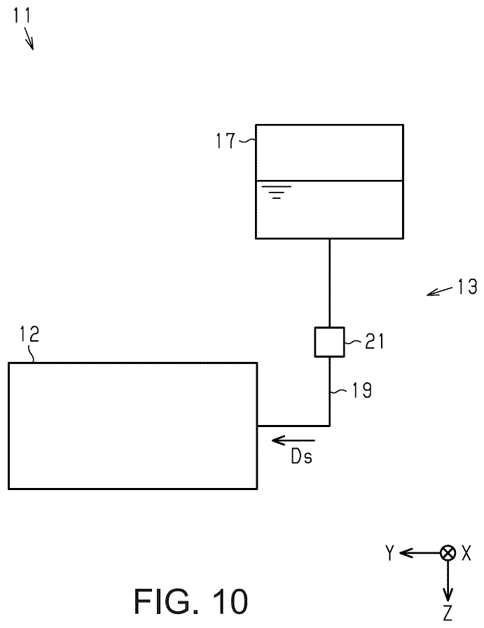

As shown in FIG. 10, the liquid ejection device 11 may supply the liquid stored in the liquid storage section 17 to the liquid ejection section 12 using a water head. In this case, the liquid ejection device 11 may be configured without including the pressurizing pump 20 and the liquid pump 125.

### Fifth Modification

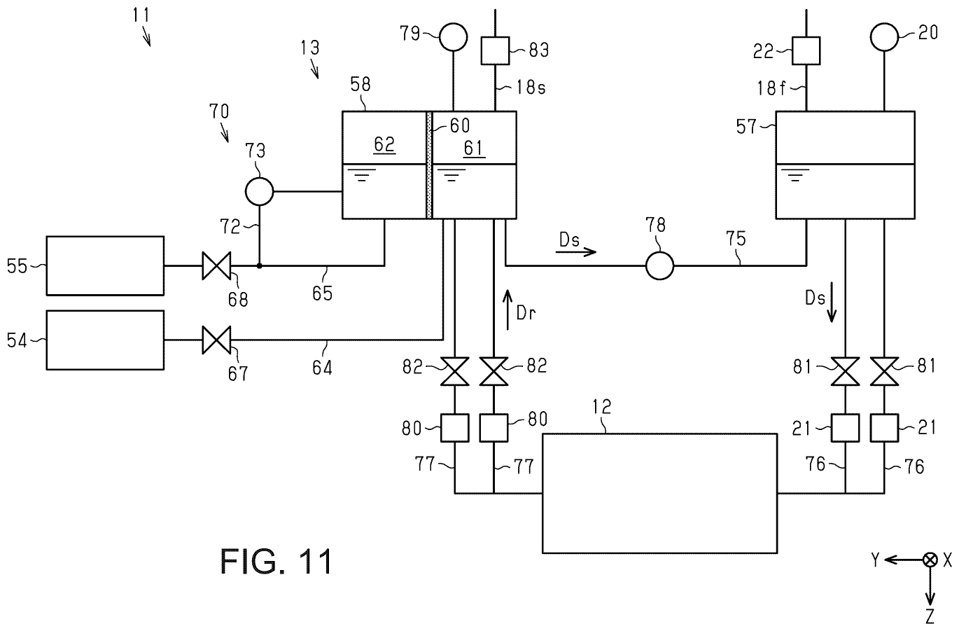

As shown in FIG. 11, the liquid ejection device 11 may include a plurality of positive pressure flow paths 76. The plurality of positive pressure flow paths 76 may merge further upstream in the supply direction Ds than the liquid ejection section 12. An upstream valve 81 and a pressure adjustment valve 21 may be provided in each of the plurality of positive pressure flow paths 76. Plural pressure adjustment valves 21 may be provided in parallel.

The liquid ejection device 11 may include a plurality of negative pressure flow paths 77. The negative pressure flow path 77 may be branched into a plurality of paths downstream in the collection direction Dr of the liquid ejection section 12. Each of the plurality of negative pressure flow paths 77 may be provided with a downstream valve 82 and a negative pressure adjustment valve 80. A plurality of negative pressure adjustment valves 80 may be provided in parallel.

The plurality of pressure adjustment valves 21 provided in the plurality of positive pressure flow paths 76 may have different pressures at which they enter the open state. The plurality of negative pressure adjustment valves 80 provided in the plurality of negative pressure flow paths 77 may have different pressures at which they enter the open state.

The liquid ejection device 11 may select the pressure adjustment valve 21 and the negative pressure adjustment valve 80 to be used by opening and closing the upstream valve 81 and the downstream valve 82. For example, in a case where the liquid is circulated, the liquid ejection device 11 may use the pressure adjustment valve 21 having a small pressure after adjustment and the negative pressure adjustment valve 80 having a small negative pressure after adjustment. At the time of circulation, a low pressure liquid may be supplied to the liquid ejection section 12, and a small negative pressure may be applied to the liquid ejection section 12.

For example, in a case where the liquid is filled into the liquid ejection section 12, the liquid ejection device 11 may use the pressure adjustment valve 21 having a large pressure after adjustment and the negative pressure adjustment valve 80 having a large negative pressure after adjustment. That is, at the time of filling, a liquid having a high pressure may be supplied to the liquid ejection section 12, and a high negative pressure may be applied to the liquid ejection section 12.

### Sixth Modification

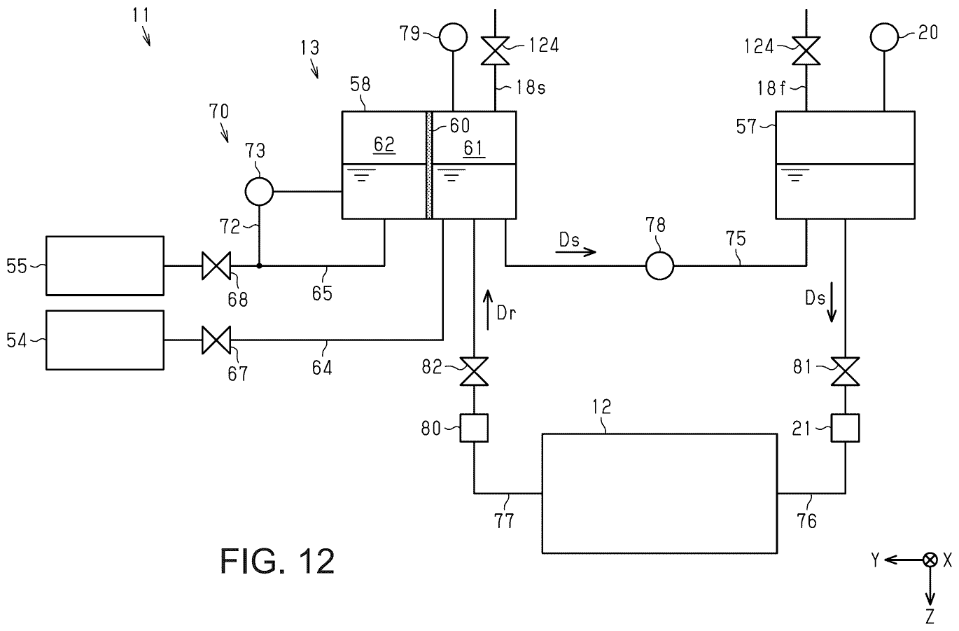

As shown in FIG. 12, the liquid ejection device 11 may include one or more atmosphere release valves 124. An atmosphere release valve 124 may be provided in the first gas flow path 18f and in the second gas flow path 18s. The atmosphere release valve 124 provided in the first gas flow path 18f can open the inside of the first tank 57 to atmosphere. The atmosphere release valve 124 provided in the second gas flow path 18s can open the inside of the second tank 58 to atmosphere.

### Seventh Modification

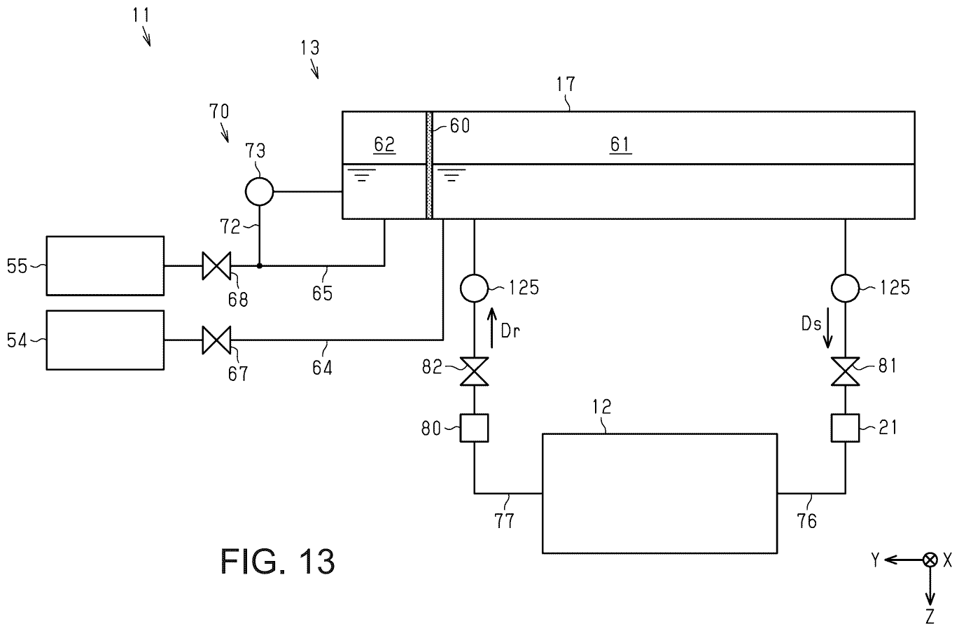

As shown in FIG. 13, the liquid storage section 17 may have a moisture permeable membrane 60. The moisture permeable membrane 60 may divide the inside of the liquid storage section 17 into a liquid chamber 61 and a humectant liquid chamber 62. The upstream end of the positive pressure flow path 76 in the supply direction Ds may be connected to the liquid storage section 17. The downstream end of the negative pressure flow path 77 in the collection direction Dr may be connected to the liquid storage section 17. The liquid pump 125 may be provided in the positive pressure flow path 76 between the liquid storage section 17 and the upstream valve 81. The liquid pump 125 may be provided in the negative pressure flow path 77 between the downstream valve 82 and the liquid storage section 17.

### Eighth Modification

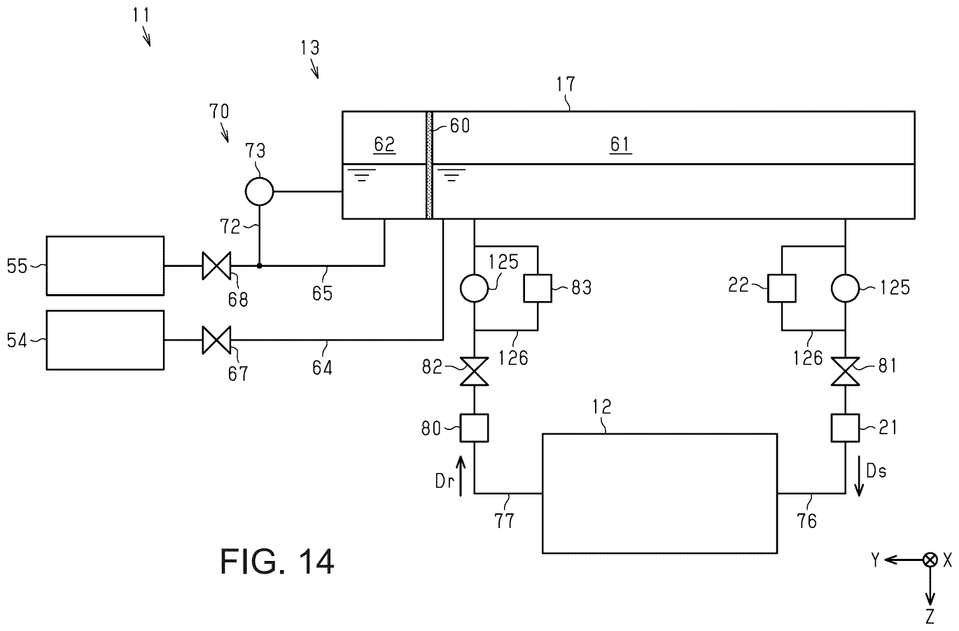

As shown in FIG. 14, the liquid ejection device 11 may include one or more relief flow paths 126.

A pressure release valve 22 may be provided in the relief flow path 126 connected to the positive pressure flow path 76. The pressure release valve 22 circulates the liquid in the relief flow path 126 in a case where the pressure downstream of the liquid pump 125 in the supply direction Ds becomes higher than a predetermined pressure.

A negative pressure release valve 83 may be provided in the relief flow path 126 connected to the negative pressure flow path 77. The negative pressure release valve 83 circulates the liquid in the relief flow path 126 in a case where the negative pressure on the upstream side of the liquid pump 125 in the collection direction Dr becomes larger than a predetermined negative pressure.

### Ninth Modification

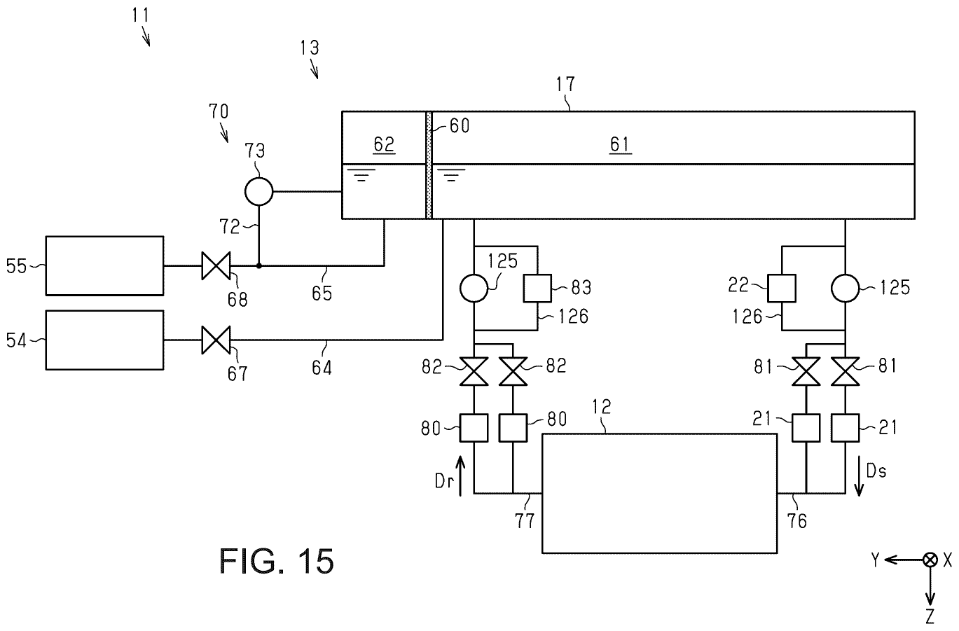

As illustrated in FIG. 15, the positive pressure flow path 76 may branch into a plurality of flow paths on the downstream side of the relief flow path 126 in the supply direction Ds and may merge on the upstream side of the liquid ejection section 12 in the supply direction Ds. An upstream valve 81 and a pressure adjustment valve 21 may be provided in each of the branched positive pressure flow paths 76. Plural pressure adjustment valves 21 may be provided in parallel.

The negative pressure flow path 77 may branch into a plurality of paths downstream of the liquid ejection section 12 in the collection direction Dr and may merge upstream of the relief flow path 126 in the collection direction Dr. Each of the plurality of negative pressure flow paths 77 may be provided with a downstream valve 82 and a negative pressure adjustment valve 80. A plurality of negative pressure adjustment valves 80 may be provided in parallel.

### Tenth Modification

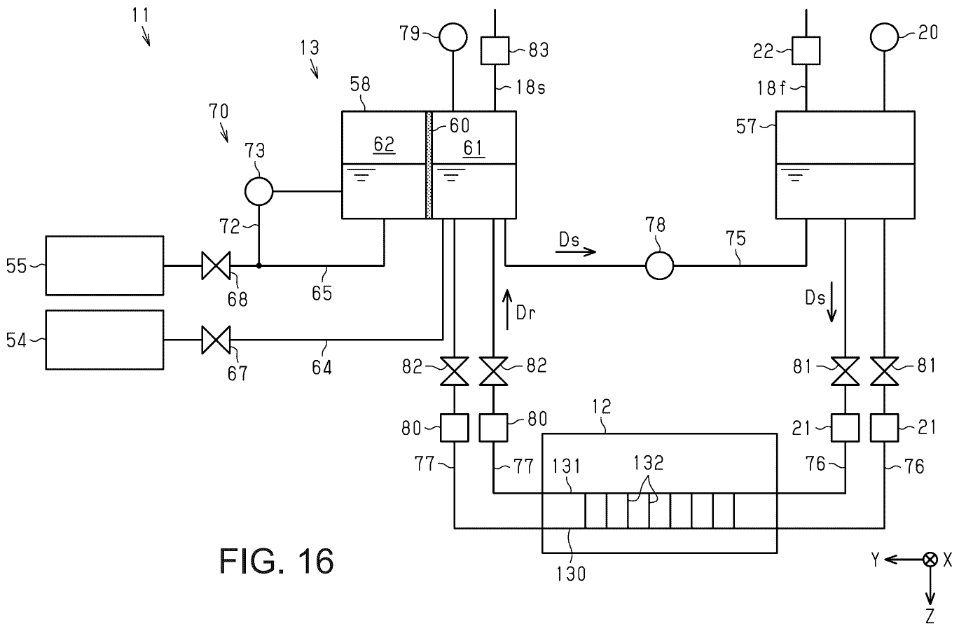

As shown in FIG. 16, a plurality of positive pressure flow paths 76 may each be connected to the liquid ejection section 12. A plurality of negative pressure flow paths 77 may each be connected to the liquid ejection section 12. The liquid ejection section 12 may include a high pressure flow path 130, a low pressure flow path 131, and a plurality of pressure difference flow paths 132.

The plurality of pressure adjustment valves 21 provided in the plurality of positive pressure flow paths 76 have different pressures at which the valves enter the open state. The plurality of negative pressure adjustment valves 80 provided in the plurality of negative pressure flow paths 77 have different pressures at which they enter the open state.

The high pressure flow path 130 and the low pressure flow path 131 each connect a positive pressure flow path 76 and a negative pressure flow path 77 together. Each of the plurality of pressure difference flow paths 132 connects the high pressure flow path 130 and the low pressure flow path 131 together. The liquid in the high pressure flow path 130 has a higher pressure than the liquid in the low pressure flow path 131. Therefore, the liquid flows from the high pressure flow path 130 toward the low pressure flow path 131 through the pressure difference flow paths 132. The nozzles 15 may be provided in the pressure difference flow path 132.

### Eleventh Modification

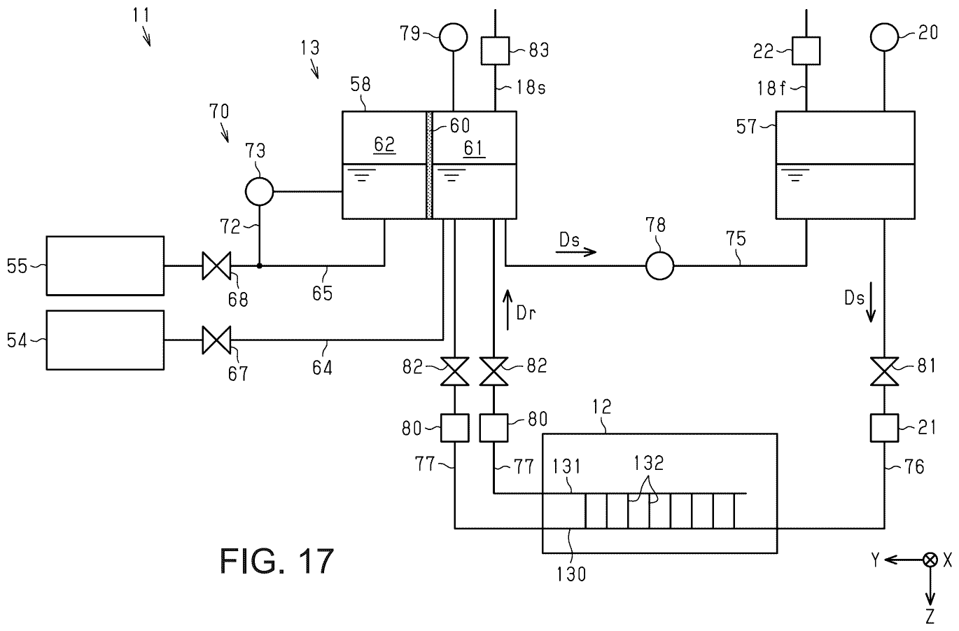

As shown in FIG. 17, the liquid ejection device 11 may include a single positive pressure flow path 76 and a plurality of negative pressure flow paths 77. The positive pressure flow path 76 is connected to the first tank 57 and the high pressure flow path 130.

### Twelfth Modification

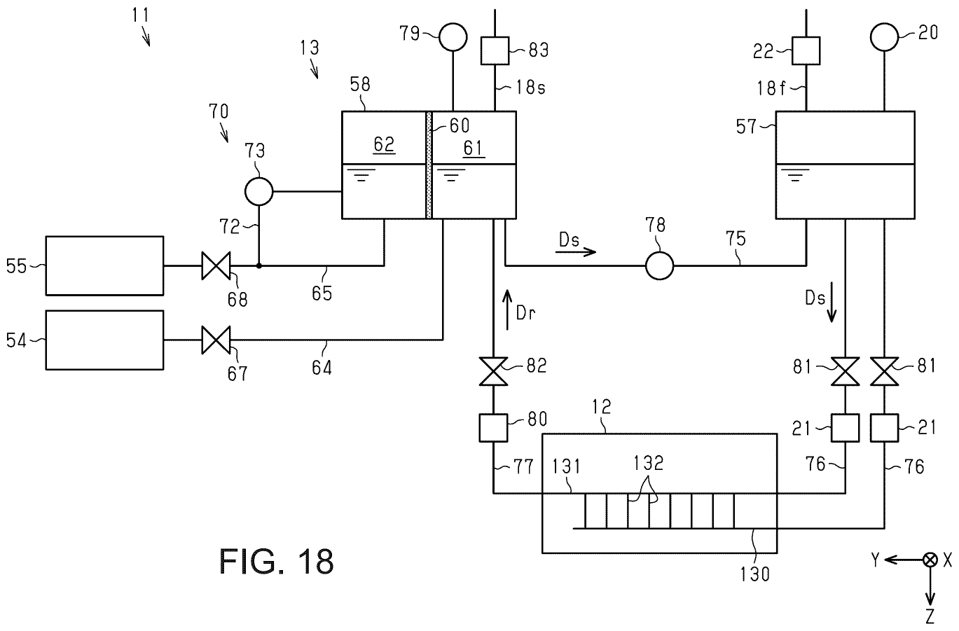

As shown in FIG. 18, the liquid ejection device 11 may include a plurality of positive pressure flow paths 76 and a single negative pressure flow path 77. The negative pressure flow path 77 is connected to the low pressure flow path 131 and the second tank 58.

### Thirteenth Modification

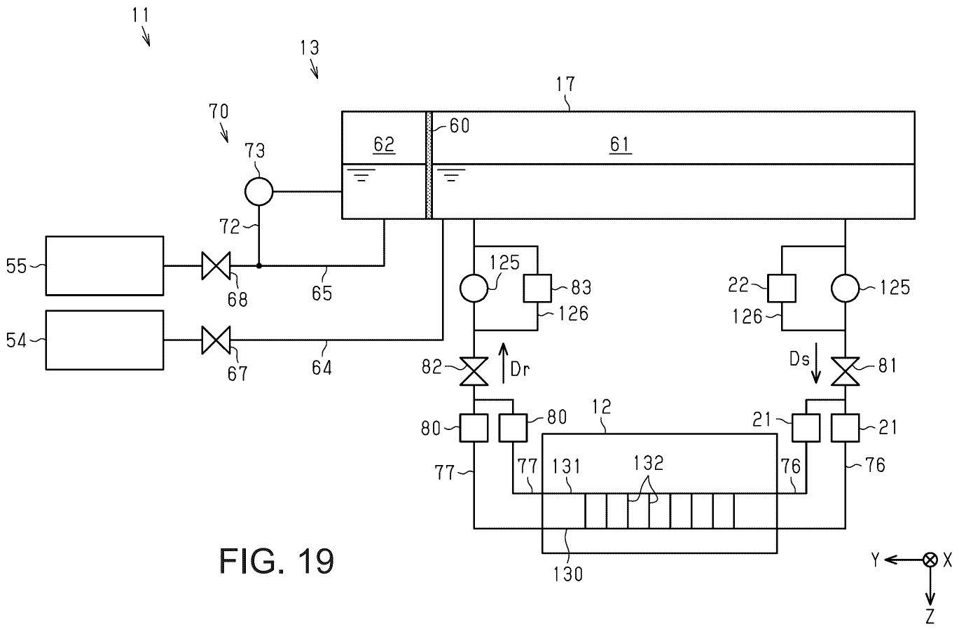

As shown in FIG. 19, the positive pressure flow path 76 may branch downstream of the upstream valve 81 in the supply direction Ds. A pressure adjustment valve 21 may be provided in each of the branched positive pressure flow paths 76. The branched positive pressure flow paths 76 may be connected to the high pressure flow path 130 and the low pressure flow path 131.

A plurality of negative pressure flow paths 77 may be connected to the high pressure flow path 130 and the low pressure flow path 131. Each of the plurality of negative pressure flow paths 77 may be provided with a negative pressure adjustment valve 80. The plurality of negative pressure flow paths 77 may merge upstream of the downstream valve 82 in the collection direction Dr.

### Fourteenth Modification

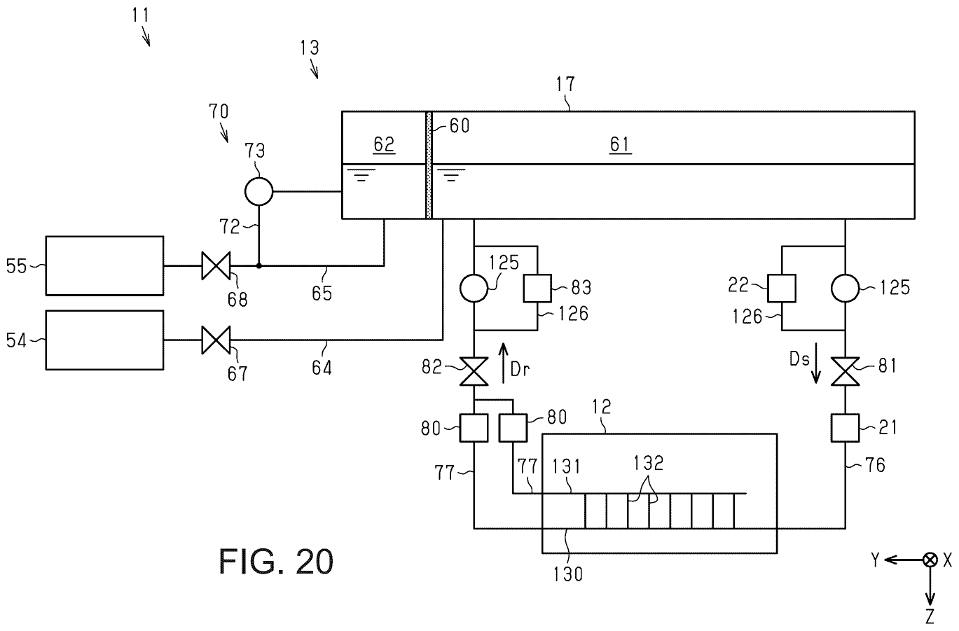

As shown in FIG. 20, the positive pressure flow path 76 may connect the liquid storage section 17 and the high pressure flow path 130 together. A plurality of negative pressure flow paths 77 connected to the high pressure flow path 130 and the low pressure flow path 131 may merge upstream of the downstream valve 82 in the collection direction Dr.

### Fifteenth Modification

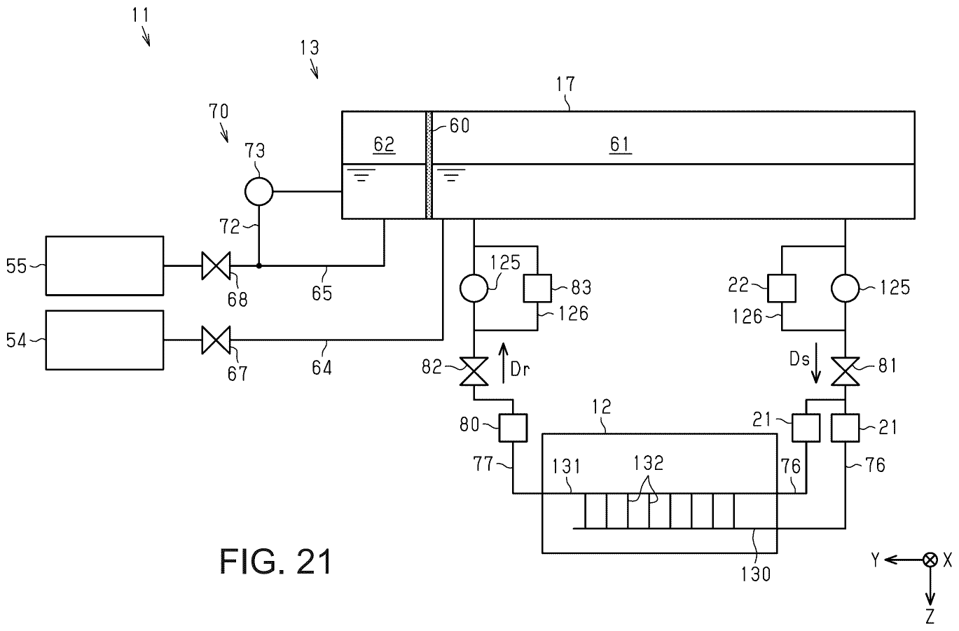

As shown in FIG. 21, the positive pressure flow path 76 may branch downstream of the upstream valve 81 in the supply direction Ds and may be connected to the high pressure flow path 130 and to the low pressure flow path 131. The negative pressure flow path 77 may connect the low pressure flow path 131 and the liquid storage section 17.

### Other Modifications

The liquid ejection device 11 may be configured to include one of either the pressure adjustment valve 21 or the negative pressure adjustment valve 80. The liquid ejection device 11 may supply the liquid by controlling the pressurizing pump 20, the pressure reduction pump 79, atmosphere release valve 124, the upstream valve 81, the downstream valve 82, or the like.
In the pressure adjustment valve 21, the pressure receiving area of the second flexible membrane 27 and the pressure receiving area of the first valve section 36 in the first upstream chamber 24 may be different. The pressure adjustment valve 21 may adjust the pressure receiving area according to the posture, the type of fluid to be handled, the ease of deformation of the second flexible membrane 27, and the like.
In the pressure release valve 22, the pressure receiving area of the sixth flexible membrane 42 and the pressure receiving area of the third valve section 51 in the third downstream chamber 40 may be different. In the pressure release valve 22, the pressure receiving area may be adjusted according to the posture, the type of fluid to be handled, the ease of deformation of the sixth flexible membrane 42, and the like.
In the negative pressure adjustment valve 80, the pressure receiving area of the fourth flexible membrane 92 in the second downstream chamber 90 may be different from the pressure receiving area of the second valve section 101. In the negative pressure adjustment valve 80, the pressure receiving area may be adjusted according to the posture, the type of fluid to be handled, the ease of deformation of the fourth flexible membrane 92, and the like.
In the negative pressure release valve 83, the pressure receiving area of the eighth flexible membrane 107 and the pressure receiving area of the fourth valve section 116 in the fourth upstream chamber 104 may be different. The pressure receiving area in the negative pressure release valve 83 may be adjusted according to the posture, the type of fluid to be handled, the ease of deformation of the eighth flexible membrane 107, and the like.
In the pressure adjustment valve 21, the bending amount of the first flexible membrane 26 when the first open and close section 28 is in the closed state may be larger than the bending amount of the first flexible membrane 26 when the first open and close section 28 is in the open state.
In the pressure release valve 22, the bending amount of the fifth flexible membrane 41 when the third open and close section 43 is in the closed state may be larger than the bending amount of the fifth flexible membrane 41 when the third open and close section 43 is in the open state.
In the negative pressure adjustment valve 80, the bending amount of the third flexible membrane 91 when the second open and close section 93 is in the closed state may be larger than the bending amount of the third flexible membrane 91 when the second open and close section 93 is in the open state.
In the negative pressure release valve 83, the bending amount of the seventh flexible membrane 106 when the fourth open and close section 108 is in the closed state may be larger than the bending amount of the seventh flexible membrane 106 when the fourth open and close section 108 is in the open state.
In the pressure adjustment valve 21, the bending amount of the second flexible membrane 27 when the first open and close section 28 is in the closed state may be larger than the bending amount of the second flexible membrane 27 when the first open and close section 28 is in the open state.
In the pressure release valve 22, the bending amount of the sixth flexible membrane 42 when the third open and close section 43 is in the closed state may be larger than the bending amount of the sixth flexible membrane 42 when the third open and close section 43 is in the open state.
In the negative pressure adjustment valve 80, the bending amount of the fourth flexible membrane 92 when the second open and close section 93 is in the closed state may be larger than the bending amount of the fourth flexible membrane 92 when the second open and close section 93 is in the open state.
In the negative pressure release valve 83, the bending amount of the eighth flexible membrane 107 when the fourth open and close section 108 is in the closed state may be larger than the bending amount of the eighth flexible membrane 107 when the fourth open and close section 108 is in the open state.
The first seal section 37 may be provided in the first communication port 32. The second seal section 102 may be provided in the second communication port 97. The third seal section 52 may be provided in the third communication port 47. The fourth seal section 117 may be provided in the fourth communication port 112.
The first shaft section 35 and the second flexible membrane 27 may be integrally formed. The second shaft section 100 and the fourth flexible membrane 92 may be integrally formed. The third shaft section 50 and the sixth flexible membrane 42 may be integrally formed. The fourth shaft section 115 and the eighth flexible membrane 107 may be integrally formed.
The liquid fluid device 13 may include the negative pressure release valve 83 instead of the pressure adjustment valve 21. The negative pressure release valve 83 adjusts the negative pressure on the side of the liquid ejection section 12 in the liquid flow path 19 or in the positive pressure flow path 76. The negative pressure release valve 83 supplies liquid to the liquid ejection section 12 by entering the open state when the negative pressure on the liquid ejection section 12 side increases.
The pressure pump 20 may be provided separately from the liquid ejection device 11.
The pressure adjustment valve 21 may be provided in a pressurization flow path that connects the pressure pump 20 and the first tank 57. When the positive pressure in the first tank 57 decreases, the pressure adjustment valve 21 may enter the open state to supply pressurized air to the first tank 57. The pressure adjustment valve 21 may regulate the pressure of the gas.
The negative pressure adjustment valve 80 may be provided in the pressure reduction flow path that connects the pressure reduction pump 79 and the second tank 58. When the negative pressure in the second tank 58 decreases, the negative pressure adjustment valve 80 may enter the open state to depressurize the inside of the second tank 58. The negative pressure adjustment valve 80 may regulate the pressure of the gas.
The liquid ejection device 11 may include a plurality of liquid fluid devices 13. The plurality of liquid fluid devices 13 may supply different types of liquids to the liquid ejection section 12. The liquids of different types are, for example, inks of different colors. One pressure pump 20 may pressurize a plurality of first tanks 57. One pressure reduction pump 79 may depressurize a plurality of second tanks 58.
The liquid ejection device 11 may be a liquid ejection device that sprays or ejects liquid other than ink. The state of the liquid that is ejected from the liquid ejection device in the form of a minute amount of liquid droplets includes a granular shape, a tear shape, and a shape with a thread-like tail. Here, the liquid may be any material that can be ejected from the liquid ejection device. For example, the liquid may be in a state where a substance is in a liquid phase and includes a fluid body such as a liquid body having high or low viscosity, sol, gel water, other inorganic solvents, an organic solvent, a solution, a liquid resin, and a liquid metal (metal melt). The liquid includes not only a liquid as one state of a substance but also a liquid in which particles of a functional material made of a solid material such as a pigment or metal particles are dissolved, dispersed, or mixed in a solvent. Typical examples of the liquid include ink as described in the above embodiment and liquid crystal. Here, ink encompasses various liquid compositions such as general water-based ink, oil-based ink, gel ink, and hot-melt ink. As a specific example of the liquid ejection device, there is a device that ejects a liquid containing, in a dispersed or dissolved form, a material such as an electrode material or a color material used for manufacturing a liquid crystal display, an electroluminescence display, a surface emitting display, a color filter, or the like. The liquid ejection device may be a device that ejects a bio-organic substance used for manufacturing a biochip, a device that is used as a precision pipette and that ejects a liquid serving as a sample, a textile printing device, a micro dispenser, or the like. The liquid ejection device may be a device that ejects lubricating oil in a pinpoint manner to precision machinery such as watches or cameras, or a device that ejects a transparent resin liquid, such as an ultraviolet curable resin, onto a substrate to form micro hemispherical lenses, optical lenses, or the like used in optical communication elements. The liquid ejection device may be a device that ejects an etching solution such as an acid or an alkali for etching a substrate or the like.

### Definitions

As used herein, the phrase “at least one” means “one or more” of the desired alternatives. As an example, the phrase “at least one” as used herein means “only one option” or “both of two options” if the number of options is two. As another example, as used herein, the phrase “at least one” means “only one option”, “a combination of two options”, or “a combination of three or more options” if the number of options is three or more.

### Supplementary Notes

Hereinafter, technical ideas grasped from the above-described embodiment and modifications, and operations and effects thereof will be described.

(A) A valve mechanism includes an upstream chamber into which fluid flows via an inflow port; a downstream chamber that has a first flexible membrane and that is in communication with the upstream chamber via a communication port downstream of the upstream chamber; a second flexible membrane that partitions the upstream chamber and the downstream chamber from each other; an open and close section configured to open and close the communication port; and a biasing section that biases the first flexible membrane in a direction in which volume of the downstream chamber decreases, wherein the open and close section includes a shaft section that is provided across the upstream chamber and the downstream chamber and that is configured to move following displacement of the first flexible membrane and the second flexible membrane and a valve section that is connected to the shaft section and that opens and closes the communication port.

According to this configuration, the pressure in the upstream chamber operates on the second flexible membrane and the valve section. The pressure of the upstream chamber operating on the valve section and the pressure of the upstream chamber operating on the second flexible membrane cancel each other out. Therefore, the opening and closing of the open and close section can be performed by fluctuation of the pressure in the downstream chamber. Therefore, variation in the pressure of the fluid can be reduced.

(B) A valve mechanism includes an upstream chamber that has a first flexible membrane and into which a fluid flows via an inflow port; a downstream chamber that is in communication with the upstream chamber via a communication port downstream of the upstream chamber; a second flexible membrane that partitions the upstream chamber and the downstream chamber from each other; an open and close section configured to open and close the communication port; and a biasing section that biases the first flexible membrane in a direction in which volume of the upstream chamber increases, wherein the open and close section includes a shaft section that is provided across the upstream chamber and the downstream chamber and that is configured to move following displacement of the first flexible membrane and the second flexible membrane and a valve section that is connected to the shaft section and that opens and closes the communication port.

According to this configuration, the pressure in the downstream chamber is acts on the second flexible membrane and the valve section. The pressure of the downstream chamber operating on the valve section and the pressure of the downstream chamber operating on the second flexible membrane cancel each other out. Therefore, the opening and closing of the open and close section can be performed by fluctuation of the pressure in the upstream chamber. Therefore, variation in the pressure of the fluid can be reduced.

(C) The valve mechanism according to (A) or (B) may be such that the shaft section is inserted into the second flexible membrane, one end of the shaft section is connected to the first flexible membrane, and an other end of the shaft section is connected to the valve section.

According to this configuration, one end of the shaft section is connected to the first flexible membrane, and the other end is connected to the valve section. Therefore, for example, compared to a case where the first flexible membrane and the valve section are connected to an intermediate part of the shaft section, the valve mechanism can be miniaturized.

(D) The valve mechanism according to (A) to (C) may be such that the valve section has a seal section configured to intimately contact the communication port.

According to this configuration, the valve section has the seal section. The seal section can intimately contact the communication port. Therefore, the sealing property of the communication port can be enhanced.

(E) The valve mechanism according to (A) to (D) may be such that a bending amount of the first flexible membrane when the open and close section is in a closed state is smaller than a bending amount of the first flexible membrane when the open and close section is in an open state and a bending amount of the second flexible membrane when the open and close section is in the closed state is smaller than a bending amount of the second flexible membrane when the open and close section is in the open state.

The first flexible membrane and the second flexible membrane, which are bent by receiving force, try to return to a state where bending is minimal. In this regard, according to this configuration, the bending amount of the first flexible membrane and the second flexible membrane is small when the open and close section is in the closed state. Therefore, it is possible to stabilize the states of the first flexible membrane and the second flexible membrane in the closed state of the open and close section.

(F) The valve mechanism according to (A) to (E) may be such that a pressure receiving area of the second flexible membrane and a pressure receiving area of the valve section are the same.

According to this configuration, the same pressure is applied to the second flexible membrane and the valve section. Therefore, by equalizing the pressure receiving areas of the second flexible membrane and the valve section, it is possible to easily cancel out the forces applied to the second flexible membrane and the valve section.

(G) A liquid fluid device includes the valve mechanism according to (A), a liquid storage section configured to store liquid; a liquid flow path coupled to the liquid storage section; and a pressure varying mechanism configured to vary the pressure of liquid flowing through the liquid flow path, wherein the valve mechanism is provided in the liquid flow path.

According to this configuration, it is possible to achieve the same effects as those of the valve mechanism.

(H) A liquid ejection device includes the liquid fluid device according to (G) and a liquid ejection section provided in the liquid flow path, wherein the valve mechanism is provided upstream of the liquid ejection section in the liquid flow path.

According to this configuration, the valve mechanism is provided in the liquid flow path upstream of the liquid ejection section. For this reason, it is possible to accurately adjust the pressure of the liquid that flows into the liquid ejection section.

(I) A liquid fluid device includes the valve mechanism according to (B); a liquid storage section configured to store liquid; a liquid flow path coupled to the liquid storage section; and a pressure varying mechanism configured to vary the pressure of liquid flowing through the liquid flow path, wherein the valve mechanism is provided in the liquid flow path.

According to this configuration, it is possible to achieve the same effects as those of the valve mechanism.

(J) A liquid ejection device includes the liquid fluid device according to (I) and a liquid ejection section provided in the liquid flow path, wherein the valve mechanism is provided downstream of the liquid ejection section in the liquid flow path.

According to this configuration, the valve mechanism is provided in the liquid flow path downstream of the liquid ejection section. Therefore, it is possible to accurately adjust the pressure of the liquid which is caused to flow out from the liquid ejection section.

(K) The liquid fluid device according to (G) may be such that it further includes a second valve mechanism, wherein, assuming that the valve mechanism is a first valve mechanism, the inflow port is a first inflow port, the upstream chamber is a first upstream chamber, the first communication port is a first communication port, the downstream chamber is a first downstream chamber the first open and close section is a first open and close section, the biasing section is a first biasing section, the shaft section is a first shaft section, and the valve section is a first valve section, the second valve mechanism includes a second upstream chamber that includes a third flexible membrane and into which fluid flows via a second inflow port, a second downstream chamber that is in communication with the second upstream chamber via a second communication port downstream of the second upstream chamber, a fourth flexible membrane that partitions the second upstream chamber and the second downstream chamber from each other, a second open and close section configured to open and close the second communication port, and a second biasing section that biases the third flexible membrane in a direction in which the volume of the second upstream chamber increases and the second open and close section includes a second shaft section that is provided across the second upstream chamber and the second downstream chamber and that is configured to move following displacement of the third flexible membrane and the fourth flexible membrane and a second valve section that is connected to the second shaft section and that opens and closes the second communication port.

According to this configuration, when the pressurization of the first downstream chamber decreases, the first valve mechanism brings the first open and close section into the open state. The second valve mechanism brings the second open and close section into the open state when the negative pressure in the second upstream chamber decreases. Therefore, by using the first valve mechanism and the second valve mechanism in accordance with the fluid pressure, it is possible to stabilize the pressure of both the positive pressure fluid and the negative pressure fluid.

(L) A liquid ejection device includes the liquid fluid device according to (K) and a liquid ejection section configured to eject liquid, wherein the liquid flow path includes a first liquid flow path having a downstream end connected to the liquid ejection section and a second liquid flow path having an upstream end connected to the liquid ejection section, the first valve mechanism is positioned in the first liquid flow path, and the second valve mechanism is located in the second liquid flow path.

According to this configuration, the first valve mechanism is provided in the first liquid flow path on the upstream side of the liquid ejection section. The second valve mechanism is provided in the second liquid flow path downstream of the liquid ejection section. Therefore, it is possible to accurately adjust the pressure of the liquid that flows into the liquid ejection section and the pressure of the liquid that flows out from the liquid ejection section.

What is claimed is:

1. A valve mechanism comprising:
an upstream chamber into which fluid flows via an inflow port;
a downstream chamber that has a first flexible membrane and that is in communication with the upstream chamber via a communication port downstream of the upstream chamber;
a second flexible membrane that partitions the upstream chamber and the downstream chamber from each other;
an open and close section configured to open and close the communication port; and
a biasing section that biases the first flexible membrane in a direction in which volume of the downstream chamber decreases, wherein
the open and close section includes
a shaft section that is provided across the upstream chamber and the downstream chamber and that is configured to move following displacement of the first flexible membrane and the second flexible membrane and
a valve section that is connected to the shaft section and that opens and closes the communication port.

2. A valve mechanism comprising:
an upstream chamber that has a first flexible membrane and into which a fluid flows via an inflow port;
a downstream chamber that is in communication with the upstream chamber via a communication port downstream of the upstream chamber;
a second flexible membrane that partitions the upstream chamber and the downstream chamber from each other;
an open and close section configured to open and close the communication port; and
a biasing section that biases the first flexible membrane in a direction in which volume of the upstream chamber increases, wherein
the open and close section includes
a shaft section that is provided across the upstream chamber and the downstream chamber and that is configured to move following displacement of the first flexible membrane and the second flexible membrane and
a valve section that is connected to the shaft section and that opens and closes the communication port.

3. The valve mechanism according to claim 1, wherein
the shaft section is inserted into the second flexible membrane,
one end of the shaft section is connected to the first flexible membrane, and
an other end of the shaft section is connected to the valve section.

4. The valve mechanism according to claim 1, wherein
the valve section has a seal section configured to intimately contact the communication port.

5. The valve mechanism according to claim 1, wherein
a bending amount of the first flexible membrane when the open and close section is in a closed state is smaller than a bending amount of the first flexible membrane when the open and close section is in an open state and
a bending amount of the second flexible membrane when the open and close section is in the closed state is smaller than a bending amount of the second flexible membrane when the open and close section is in the open state.

6. The valve mechanism according to claim 1, wherein
a pressure receiving area of the second flexible membrane and a pressure receiving area of the valve section are the same.

7. A liquid fluid device comprising:
the valve mechanism according to claim 1;
a liquid storage section configured to store liquid;
a liquid flow path coupled to the liquid storage section; and
a pressure varying mechanism configured to vary the pressure of liquid flowing through the liquid flow path, wherein
the valve mechanism is provided in the liquid flow path.

8. A liquid ejection device comprising:
the liquid fluid device according to claim 7 and
a liquid ejection section provided in the liquid flow path, wherein
the valve mechanism is provided upstream of the liquid ejection section in the liquid flow path.

9. A liquid fluid device comprising:
the valve mechanism according to claim 2;
a liquid storage section configured to store liquid;
a liquid flow path coupled to the liquid storage section; and
a pressure varying mechanism configured to vary the pressure of liquid flowing through the liquid flow path, wherein
the valve mechanism is provided in the liquid flow path.

10. A liquid ejection device comprising:
the liquid fluid device according to claim 9 and
a liquid ejection section provided in the liquid flow path, wherein
the valve mechanism is provided downstream of the liquid ejection section in the liquid flow path.

11. The liquid fluid device according to claim 7, further comprising:
a second valve mechanism, wherein, assuming that
the valve mechanism is a first valve mechanism,
the inflow port is a first inflow port,
the upstream chamber is a first upstream chamber,
the first communication port is a first communication port,
the downstream chamber is a first downstream chamber
the first open and close section is a first open and close section,
the biasing section is a first biasing section,
the shaft section is a first shaft section, and
the valve section is a first valve section,
the second valve mechanism includes
a second upstream chamber that includes a third flexible membrane and into which fluid flows via a second inflow port,
a second downstream chamber that is in communication with the second upstream chamber via a second communication port downstream of the second upstream chamber,
a fourth flexible membrane that partitions the second upstream chamber and the second downstream chamber from each other,
a second open and close section configured to open and close the second communication port, and
a second biasing section that biases the third flexible membrane in a direction in which the volume of the second upstream chamber increases and
the second open and close section includes
a second shaft section that is provided across the second upstream chamber and the second downstream chamber and that is configured to move following displacement of the third flexible membrane and the fourth flexible membrane and
a second valve section that is connected to the second shaft section and that opens and closes the second communication port.

12. A liquid ejection device comprising:
the liquid fluid device according to claim 11 and
a liquid ejection section configured to eject liquid, wherein
the liquid flow path includes
a first liquid flow path having a downstream end connected to the liquid ejection section and
a second liquid flow path having an upstream end connected to the liquid ejection section,
the first valve mechanism is positioned in the first liquid flow path, and
the second valve mechanism is located in the second liquid flow path.
